(19) United States
(12) Patent Application Publication
(10) Pub. No.: US 2026/0252947 A1
(43) Pub. Date: Aug. 27, 2026

(54) Systems and Methods for Skillset Augmentation of Artificial Intelligence Agents

(71) Applicant: GDM Holding LLC, Mountain View, CA (US)

(72) Inventors: Victor Carbune, Zurich (CH); Florian Nils Hartmann, Zurich (CH)

(21) Appl. No.: 19/059,701

(22) Filed: Feb. 21, 2025

(51) Int. Cl. G06N 20/00

(52) U.S. Cl. CPC G06N 20/00

(57) ABSTRACT

Systems and methods described herein provide for identifying a skillset to augment in a learner agent system; selecting, from a pool of candidate instructor agent systems associated with a multiagent training platform, one or more instructor agent systems based on instructor skills documentation data descriptive of respective skill capabilities of the candidate instructor agent systems; obtaining at least one training task representative of the skillset; generating a learner solution to the at least one training task using the learner agent system; generating instructor feedback data using the one or more instructor agent systems and the at least one training task, the instructor feedback data descriptive of a quality of the learner solution; and training the learner agent system based on the instructor feedback data.

### FIELD

The present disclosure relates generally to artificial intelligence systems. More particularly, the present disclosure relates to systems and methods for skillset augmentation of artificial intelligence agents.

### BACKGROUND

An artificial intelligence agent (“agent”) can include a set of computer-executable instructions and/or other computer-readable information that is collectively configured to process inputs to generate outputs. For example, an agent can receive data, apply computational processes to analyze the data according to programmed algorithms or models, and produce results that are determined by the parameters and/or structure of the underlying algorithms or models.

### SUMMARY

Aspects and advantages of embodiments of the present disclosure will be set forth in part in the following description, or can be learned from the description, or can be learned through practice of the embodiments.

For example, in an aspect, the present disclosure provides a computer-implemented method. The method includes identifying a skillset to augment in a learner agent system. The method includes selecting, from a pool of candidate instructor agent systems associated with a multiagent training platform, one or more instructor agent systems based on instructor skills documentation data descriptive of respective skill capabilities of the candidate instructor agent systems. The method includes obtaining at least one training task representative of the skillset. The method includes generating a learner solution to the at least one training task using the learner agent system. The method includes generating instructor feedback data using the one or more instructor agent systems and the at least one training task, the instructor feedback data descriptive of a quality of the learner solution. The method includes training the learner agent system based on the instructor feedback data.

In some implementations, identifying the skillset includes determining to augment the learner agent system with the skillset.

In some implementations, determining to augment the learner agent system with the skillset includes determining an inadequate prediction quality of the learner agent system on the skillset.

In some implementations, determining the inadequate prediction quality of the learner agent system of the skillset includes generating an output of the learner agent system by performing a task representative of the skillset and determining that a quality score of the output is within an inadequate prediction quality score range.

In some implementations, determining to augment the learner agent system with the skillset includes receiving an augment request from a user indicating to augment the learner agent system with the skillset.

In some implementations, the instructor skills documentation data is generated based on historical training performance of the pool of candidate instructor agent systems.

In some implementations, the instructor skills documentation data includes self-identified skill capabilities from the pool of candidate instructor agent systems.

In some implementations, the method further includes generating an instructor solution to the at least one training task using the one or more instructor agent systems. In some implementations, the method further includes providing the instructor solution to the learner agent system. In some implementations, the method further includes, responsive to the instructor solution, generating the learner solution to the at least one training task.

In some implementations, the instructor solution includes progress data indicative of a progress toward a final value at each stage of the instructor solution.

In some implementations, the method further includes providing the learner agent system and the one or more instructor agent systems in an interagent communication environment of the multiagent training platform.

In some implementations, providing the instructor solution to the learner agent system is performed via the interagent communication environment.

In some implementations, providing the learner agent system and the one or more instructor agent systems in the interagent communication environment includes establishing communication between the learner agent system and the one or more instructor agent systems and providing one or more initialization instructions to the learner agent system and the one or more instructor agent systems.

In some implementations, the one or more initialization instructions include one or more of an introductory instruction, a transfer learning instruction, a prior learning instruction, or a tool availability instruction.

In some implementations, obtaining the at least one training task includes generating the at least one training task using the one or more instructor agent systems.

In some implementations, generating the at least one training task using the one or more instructor agent systems includes evaluating a performance capability of the learner agent system on the skillset and generating, using the one or more instructor agent systems, the at least one training task based on the performance capability of the learner agent system on the skillset.

In some implementations, obtaining the at least one training task includes retrieving the at least one training task from a training task dataset including the at least one training task.

In some implementations, the instructor feedback data includes contextual feedback relative to a portion of the learner solution.

In some implementations, the method further includes, subsequent to training the learner agent system based on the learner solution, generating at least one second training task representative of the skillset.

In some implementations, the method further includes, subsequent to training the learner agent system based on the learner solution, obtaining a request from a user to perform an inference task representative of the skillset and generating an output of the learner agent system by performing the inference task, wherein the learner agent system is enabled to perform the inference task based on training the learner agent system.

For example, in an aspect, the present disclosure provides a computing system including one or more processors and one or more non-transitory, computer-readable media storing instructions that, when implemented, cause the one or more processors to perform operations. The operations include identifying a skillset to augment in a learner agent system. The operations include selecting, from a pool of candidate instructor agent systems associated with a multiagent training platform, one or more instructor agent systems based on instructor skills documentation data descriptive of respective skill capabilities of the candidate instructor agent systems. The operations include obtaining at least one training task representative of the skillset. The operations include generating a learner solution to the at least one training task using the learner agent system. The operations include generating instructor feedback data using the one or more instructor agent systems and the at least one training task, the instructor feedback data descriptive of a quality of the learner solution. The operations include training the learner agent system based on the instructor feedback data.

For example, in an aspect, the present disclosure provides a computer-readable media storing instructions that, when implemented, cause one or more processors to perform operations. The operations include identifying a skillset to augment in a learner agent system. The operations include selecting, from a pool of candidate instructor agent systems associated with a multiagent training platform, one or more instructor agent systems based on instructor skills documentation data descriptive of respective skill capabilities of the candidate instructor agent systems. The operations include obtaining at least one training task representative of the skillset. The operations include generating a learner solution to the at least one training task using the learner agent system. The operations include generating instructor feedback data using the one or more instructor agent systems and the at least one training task, the instructor feedback data descriptive of a quality of the learner solution. The operations include training the learner agent system based on the instructor feedback data.

Other example aspects of the present disclosure are directed to other systems, methods, apparatuses, tangible non-transitory computer-readable media, and devices for performing functions described herein. These and other features, aspects, and advantages of various implementations will become better understood with reference to the following description and appended claims. The accompanying drawings, which are incorporated in and constitute a part of this specification, illustrate implementations of the present disclosure and, together with the description, help explain the related principles.

### BRIEF DESCRIPTION OF THE DRAWINGS

FIG. 1-3B are block diagrams of example systems according to example implementations of aspects of the present disclosure;

FIG. 4 is a flow chart diagram illustrating an example method according to example implementations of aspects of the present disclosure;

FIG. 5 is a flow chart diagram illustrating an example method for training a machine-learned model according to example implementations of aspects of the present disclosure;

FIG. 6 is a block diagram of an example processing flow for using machine-learned model(s) to process input(s) to generate output(s) according to example implementations of aspects of the present disclosure;

FIG. 7 is a block diagram of an example sequence processing model according to example implementations of aspects of the present disclosure;

FIG. 8 is a block diagram of an example technique for populating an example input sequence for processing by a sequence processing model according to example implementations of aspects of the present disclosure;

FIG. 9 is a block diagram of an example model development platform according to example implementations of aspects of the present disclosure;

FIG. 10 is a block diagram of an example training workflow for training a machine-learned model according to example implementations of aspects of the present disclosure;

FIG. 11 is a block diagram of an inference system for operating one or more machine-learned model(s) to perform inference according to example implementations of aspects of the present disclosure;

FIG. 12 is a block diagram of an example networked computing system according to example implementations of aspects of the present disclosure;

FIG. 13 is a block diagram of an example computing device according to example implementations of aspects of the present disclosure; and

FIG. 14 is a block diagram of an example computing device according to example implementations of aspects of the present disclosure.

### DETAILED DESCRIPTION

The present disclosure describes computer systems and methods for implementing an agent system with improved performance. The agent system can be an artificial intelligence (“AI”) agent. The agent system can utilize machine-learned models and AI-enabled systems to help users solve tasks. For instance, the agent system can employ one or more machine-learned models to generate outputs responsive to queries from users. As one example, an agent system can be or can include a computing system including one or more machine-learned models, where the computing system is configured to receive an input from a user device or calling device and provide an output responsive to the input to the user device or calling device. The agent system can be or can implement a multi-modal agent (e.g., a multi-modal artificial intelligence agent). For instance, a multi-modal agent can process inputs from one or more data modalities. In some implementations, the agent system can be implemented as a “situated agent”. The term situated agent refers to a setting in which the agent system shares one or more perceptual inputs with a human user. For example, the situated agent can receive and process various data inputs, including video, audio, and/or textual data which are also observable by the human user. The agent system can process these inputs to generate responses that are contextually-relevant for the user's physical or digital environment, for example enabling the agent system to generate dialogue or other responses or outputs which assist the user in understanding and/or navigating the environment.

The agent system can incorporate or benefit from a number of different aspects, including: the employment of advanced sequence processing models to enhance dialogue management; the integration of a real-time communication framework to facilitate immediate data exchange; architectural innovations that decouple input tokenization from model deployment; and/or an efficient caching strategy to optimize data flow. Additionally, the present disclosure provides systems and methods for skillset augmentation of artificial intelligence agents.

These and other aspects of the present disclosure enhance the real-time responsiveness and contextual accuracy of the agent system. In particular, by providing advanced data processing architectures and efficient communication frameworks, aspects of the present disclosure improve system performance in dynamic environments. Specifically, the systems and methods described herein can enable additional task performing functionality (referred to as an agent system's “skillset” or “skillsets”) of an existing agent system while preserving customizations and context of the agent system.

According to one aspect of the present disclosure, some example implementations of the agent system can include or leverage sequence processing models to effectively process and respond to user interactions. For example, these models, such as large-language models (LLMs) and large-multimodal models (LMMs), can process a wide range of input data types, including textual, audio, and/or visual data. By integrating these diverse data types, the agent system can generate more contextually relevant responses that are configured to the specific situation and environment of the user.

In some implementations, the sequence processing models included in or used by the agent system can be specifically fine-tuned to manage different dialogue settings. This includes both turn-based dialogues, where the interaction follows a structured turn-taking pattern, and open dialogues, where any participant may speak at any time without a predefined turn order. This flexibility allows the agent system to adapt to various conversational scenarios, maintaining fluidity and coherence in its interactions regardless of the dialogue structure.

Artificial Intelligence (AI) agents can utilize machine-learned models and AI-enabled systems to help users solve tasks. Generally, artificial intelligence agents can make use of learned skillsets to solve various tasks and implement various functionalities. For example, some agent systems may be designed to solve complex mathematics problems, while other agent systems may be designed to solve language understanding tasks, while still other agents may be designed to solve multimodal tasks. Each of these tasks can require unique training and learning by the agent systems. While a single agent system may theoretically be capable of performing these various tasks, the agent system may lack the unique skillset necessary to perform these tasks at its inception. For instance, the agent system may not be enabled to perform these tasks through conventional pre-training, post-training, or standard fine-tuning processes. As an example, at the point where an agent system is trained, the exact operational conditions of the agent system may be unknown and/or the agent system may be trained using a more general training approach that is not fine-tuned for typical operation of the agent system. As another example, the operational conditions of the agent system may differ during live operation of the agent system relative to the expected operational conditions during its training. Furthermore, agent systems may increasingly interact with new agent systems during operation and/or as the new agent systems become available. Still further, some agent systems may be subjected to a relatively static training stage that does not provide for the agent systems to interact well with more specialized agent systems.

Users of these agent systems can expect that agent systems can solve a significant variety of tasks. However, due to model capacity and/or training data limitations, the agent systems may be unable to robustly perform certain tasks for users that would otherwise be desirable to perform. Furthermore, many agent systems can adapt their operation to a user over time, such as by learning preferences or other context relative to a particular user. Because of this, it can be desirable to augment existing agent systems with new skills or functionalities while preserving the functionality and/or customizations of the existing agent system (e.g., as opposed to simply replacing the existing agent system with a new agent system enabled in such functionalities).

Example aspects of the present disclosure leverage the in-context learning capabilities of many agent systems to provide for augmenting these agent systems with additional task capabilities. In particular, the present disclosure provides a multi-agent learning setup where agents are prompted for role-playing as a learning agent and an instructor agent and whereby the learning agent is augmented with a skillset of the instruction agent. The goals and purposes of each scenario may vary based on the specific requirements of a given skillset.

Systems and methods according to the present disclosure can provide for identifying a skillset to augment in a learner agent system. The learner agent system can be any suitable agent system, such as an artificial intelligence (AI) agent system or “AI agent.” The identification of a skillset to augment in a learner agent system can occur in a variety of approaches. For instance, in some implementations, identifying the skillset can include determining to augment the learner agent system with the skillset. For instance, a user of the agent system, the agent system itself, and/or another component in a larger system implementing or operating the agent system can recognize a need, benefit, or other motivation to augment the learner agent system with the skillset to improve performance of the learner agent system during its operation.

In some implementations, the agent can be implemented as a “situated agent”. The term situated agent refers to a setting in which the agent shares one or more perceptual inputs with a human user. For example, the situated agent can receive and process various data inputs, including video, audio, and/or textual data which are also observable by the human user. The agent can process these inputs to generate responses that are contextually relevant for the user's physical or digital environment, for example enabling the agent to generate dialogue or other responses or outputs which assist the user in understanding and/or navigating the environment.

According to one aspect of the present disclosure, some example implementations of the artificial intelligence agent can include or leverage sequence processing models to effectively process and respond to user interactions. For example, these models, such as large language models (LLMs) and large-multimodal models (LMMs), can process a wide range of input data types, including textual, audio, and/or visual data. By integrating these diverse data types, the agent can generate more contextually relevant responses that are configured to the specific situation and environment of the user.

Some artificial intelligence agents may include or have access to a memory layer that enables the storage and retrieval of various types of information associated with historical usage of the artificial intelligence agents. This can include past interactions, observations, preferences, and/or environmental data. The agent can utilize this stored information to generate new predictions, outputs, or actions, effectively using historical data to inform and improve its real-time responses and decision-making processes.

As one example, in some implementations, determining to augment the learner agent system with the skillset can include determining an inadequate prediction quality of the learner agent system on the skillset. The inadequate prediction quality can signal that the learner agent system is incapable of performing tasks requiring the skillset and/or otherwise provides undesirable outputs (e.g., incorrect or low-confidence outputs) when performing the tasks requiring the skillset. The inadequate prediction quality condition can occur in response to an output of the learner agent system when performing a task. For example, in some implementations, determining the inadequate prediction quality of the learner agent system of the skillset can include generating an output of the learner agent system by performing a task representative of the skillset and determining that a quality score of the output is within an inadequate prediction quality score range. Additionally and/or alternatively, determining the inadequate prediction quality of the learner agent system of the skillset may include determining that a quality score of the output is not within an adequate prediction quality score range. The prediction quality score range can be a range of values that indicates acceptable or unacceptable quality in the output. For instance, in some implementations, the agent system itself, another agent system, and/or an evaluation model may be configured to assess or critique the outputs from the agent system to determine whether the outputs are useful, correct, or otherwise desirable or undesirable. The tasks representative of a skillset may also have a known correct answer such that a learner agent system outputting a different answer than the known correct answer can be considered as indicating that the learner agent system does not possess the associated skillset or needs to improve at that skillset. In some cases, determining to augment the learner agent system with the skillset may occur if a single output is inadequate. Still further, in some implementations, the determination to augment the learner agent system may be made after a number of inadequate outputs, such as a certain frequency or number of inadequate outputs over a given period of time.

Additionally and/or alternatively, in some implementations, determining to augment the learner agent system with the skillset can include receiving a request from a user to augment the learner agent system with the skillset. For example, in some implementations, the user may provide a spoken, typed, or other mode of request to the agent system asking the agent system to augment its capabilities to assist the user with some task. For example, the user may provide a sentence such as “the agent should have been able to solve this mathematics problem” to request that the agent system be augmented to solve mathematics problems of a similar nature. As another example, the request from a user may include some indication of negative feedback on a prior output of the agent system, such as a “thumbs down” reaction or other feedback indicative of dissatisfaction with the prior output.

Once the skillset is identified, the system can configure an instruction scenario for the agent system to be augmented with the skillset. This skillset can be imparted on the agent system through a sort of “gym” or “classroom” setting involving the interaction of the learner agent system with one or more instructor agent systems. For instance, systems and methods according to the present disclosure can provide for selecting one or more instructor agent systems based on the skillset. In particular, the systems and methods described herein can provide for selecting, from a pool of candidate instructor agent systems associated with a multiagent training platform, one or more instructor agent systems based on instructor skills documentation data descriptive of respective skill capabilities of the candidate instructor agent systems. For example, in some implementations, selecting the one or more instructor agent systems based on the instructor skills documentation data can include matching the skillset to a capability specified by the instructor skills documentation data, and selecting the matching instructor agent system. For example, if a skillset is language translation in a particular language, an instructor agent system that is indicated by the instructor skills documentation data as being capable in translating the particular language may be selected for instructing a learner agent system in translating the particular language. The multiagent training platform can be a platform for facilitating exchange, training, storage, and other communications between a plurality of agent systems for increasing availability of the agent systems.

The systems and methods can generally select instructor agent systems that are capable of and/or best at imparting the skillset to the learner agent system. In addition to the skillset, this selection process can account for other factors, such as the present capabilities of the learner agent system. For instance, in a similar manner to how a human student may struggle to understand advanced mathematics without a strong foundational understanding of arithmetic, an agent system may first learn to perform a relatively basic task in a given domain before the agent system can efficiently learn to perform more advanced tasks. Two instructor agent systems that are capable of instructing in a common domain may nonetheless be more or less efficient at instructing for particular levels or tasks within that domain. The systems and methods herein can account for the capabilities of instructor agent systems to instruct at a given level, type of task, or other differentiation within a problem domain.

In some implementations, selecting the one or more instructor agent systems can be based on instructor skills documentation data that is indicative of an instruction quality of the instructor agent systems. For instance, in some implementations, selecting the one or more instructor agent systems can include obtaining instructor skills documentation data indicative of an instruction quality of a plurality of candidate instructor agent systems relative to the skillset. The plurality of candidate instructor agent systems can be stored, referenced, or otherwise accessible or addressable by an instructor agent system repository or dataset that indexes the candidate instructor agent systems relative to the instructor skills documentation data.

The instructor skills documentation data can be any suitable data that is indicative of instruction quality. As one example, the instructor skills documentation data can be or can include a quality score or other quality metric. The instructor skills documentation data may include data corresponding to a particular task, skillset, task domain, or other suitable task descriptors. As another example, the instructor skills documentation data can be or can include a description of some quality of the instructor agent systems, such as a description of the capabilities of instructor agent systems. The description may include, for example, a plain language description (e.g., “this agent system is capable of solving polynomial equations”), metadata or tag-based descriptions (e.g., a “math-capable” tag associated with the instructor agent system), or other suitable description. In some implementations, the instructor skills documentation data can be generated based on historical training performance of the plurality of candidate instructor agent systems. For example, in a prior learning operation, a candidate instructor agent system may be used to train some other learner agent system on a particular skillset. The performance of the candidate instructor agent system in the prior learning operation can be evaluated and used to generate the instructor skills documentation data relative to the particular skillset. As another example, in some implementations, the candidate instructor agent systems may be benchmarked and scored based on performance on a curriculum of tasks corresponding to a given skillset.

Additionally and/or alternatively, in some implementations, the instructor skills documentation data can include self-identified capabilities from the plurality of candidate instructor agent systems. The self-identified capabilities can include data (e.g., text data, metadata, numerical data, etc.) that is provided by an agent system for describing a capability of the agent system. For example, to generate the self-identified capability data, a candidate instructor agent system can be prompted with a capability description request, such as a message asking the instructor agent system to describe its capabilities. In response to the capability description request, the candidate instructor agent system can respond with the self-identified capabilities, such as a scoring of its capabilities, a phrase describing its capabilities, or some other indication of domains in which the candidate instructor agent system can produce a meaningful output.

Additionally and/or alternatively, systems and methods according to the present disclosure can provide for obtaining at least one training task representative of the skillset. The training tasks can be generated or otherwise sourced in any suitable manner. For instance, in some implementations, generating the at least one training task can include generating the at least one training task using the one or more instructor agent systems. For example, the instructor agent systems can be prompted with a task generation request that instructs the instructor agent systems to generate a task. The task may be generated relative to a particular difficulty or complexity within a domain of the skillset to account for the present skill of the learner agent system. For instance, in some implementations, generating the at least one training task using the one or more instructor agent systems can include evaluating a performance capability of the learner agent system on the skillset and generating, using the one or more instructor agent systems, the at least one training task based on the performance capability of the learner agent system on the skillset. The performance capability of the learner agent system can be or can include a score, evaluation, or other indication of how skilled the learner agent system is and/or what level of difficulty or complexity of tasks the learner agent system is capable of adequately performing. Still further, in some implementations, the training tasks can be provided by a training task dataset or other repository of training tasks. For instance, in some implementations, generating the at least one training task can include accessing a training task dataset including the at least one training task. The training tasks may be indexed in the training task dataset relative to various data such as, for example, task domain, skillset, difficulty, complexity, or other data.

Additionally and/or alternatively, systems and methods according to the present disclosure can provide for, in some implementations, generating an instructor solution to the at least one training task using the one or more instructor agent systems. The instructor solution can be a correct or valid solution to the at least one training task due at least in part to the selection process of instructor agent systems. For example, by selecting instructor agent systems based on instructor skills documentation data indicating that the instructor agent systems are capable of performing tasks in the domain of the training task, the systems and methods herein can improve assurances that the instructor solution represents a valid solution to the training task. The instructor solution may not only include an ultimate answer or response to the training task, but in some implementations may additionally describe a “chain-of-thought” or step-by-step walkthrough of the solution. For instance, a higher-level task can be decomposed into a sequence of relatively simpler tasks that may be solved more trivially. For example, in a mathematics problem, the instructor solution may illustrate a progression of relatively simpler operations starting at the problem itself and progressing toward the ultimate answer. As another example, in a language translation task, the instructor solution may illustrate how various grammatical, word choice, or other linguistic rules or exceptions shape the translation. To prompt the instructor agent systems to provide a progressive solution to the training task, the instructor agent systems may be operated using self-reflection, chain-of-thought prompting, refinement, or other approaches that cause the instructor agent systems to generate progressive outputs.

Additionally and/or alternatively, systems and methods according to the present disclosure can provide for providing the instructor solution to the learner agent system. For instance, the learner agent system can consume the instructor solution as input, context, or other data that affects its operation. Responsive to the instructor solution, the learner agent system can generate a learner solution to the at least one training task. The learner solution can represent an attempt by the learner agent system to perform the training task after the instructor agent systems have demonstrated valid performance of the training task to the learner agent system. For instance, the learner solution can represent an attempt by the learner agent system to mirror performance of the skillset after it is demonstrated by the instructor solution.

Furthermore, in some implementations, the instructor solution can include progress data indicative of a progress toward a final value at each stage of the instructor solution. The progress data can be, for example, a percentage or other indication of relative progress through the instructor solution at each stage. For example, a halfway point in the instructor solution may be labeled with some metadata or otherwise indicate that the learner agent is halfway done with the task if it is able to successfully recreate the instructor solution to that point. This progress data can serve as a signal that provides for the agent systems to focus their instruction and learning on portions of the solution where the learner agent struggles.

In some implementations, to facilitate exchange of communications and solutions between the learner agent system and the instructor agent system(s), the learner agent system and the one or more instructor agent systems can be provided in an interagent communication environment (e.g., of the multiagent training platform). The interagent communication environment can be an environment that provides for one agent system to provide messages, context, and/or other inputs or outputs to another agent system. For example, the interagent communication environment can be or can include a stack, input stream, or other manner of data exchange. In particular, providing the instructor solution to the learner agent system can be performed via the interagent communication environment.

In some implementations, the interagent communication environment can be initialized to prime the learner agent system and the instructor agent system(s) for an instruction scenario. For instance, in some implementations, providing the learner agent system and the one or more instructor agent systems in the interagent communication environment can include establishing communication between the learner agent system and the one or more instructor agent systems and providing one or more initialization instructions to the learner agent system and the one or more instructor agent systems. The initialization instructions can be any suitable instructions for assigning roles and/or establishing protocols to facilitate desired operation of the learner agent system and the instructor agent system(s). In some implementations, the one or more initialization instructions comprise one or more of an introductory instruction, a transfer learning instruction, a prior learning instruction, or a tool availability instruction. For instance, the introductory instruction may be a phrase such as “This is an environment established to facilitate learning <skillset>.” Additionally or alternatively, the transfer learning instruction can describe instructions on practices for transfer learning such as a phrase requesting that the models show a chain of thought. Additionally or alternatively, the prior learning instruction can describe some prior learning tasks, such as prior demonstrations or previous steps in a larger training curriculum. Additionally and/or alternatively, the tool availability instruction can describe which tools (e.g., a calculator, a search engine, etc.) can be used for learning or used during learning. In some implementations, some tools may be directly used for teaching (e.g., a knowledge engine) whereas some other tools may be used to generate only a portion of a complete solution, such as a calculator for performing arithmetic operations without necessarily learning to perform arithmetic operations independently of the calculator.

Additionally and/or alternatively, systems and methods according to the present disclosure can provide for generating instructor feedback data using the one or more instructor agent systems and the at least one training task and training the learner agent system based on the instructor feedback data. The instructor feedback data can be descriptive of a quality of the learner solution. For instance, the learner solution can be used to produce a loss, feedback signal, or other suitable signal that can be used to modify one or more parameters of the learner agent system to improve a capability level of the learner agent system relative to the skillset. As one example, if the learner agent system employs one or more machine-learned models, the parameters of the machine-learned models may be altered responsive to the shortcomings in the learner solution to improve future predictions from the machine-learned models. As one example, training the learner agent system based on the learner solution can include assessing a quality of the learner solution using the one or more instructor models and providing the learner agent system with contextual feedback based on the quality of the learner solution. The quality can be, for example, a quality score, such as a score reflective of an accuracy or other quality of the learner solution, a similarity score between the learner solution and the instructor solution, or some other suitable data indicative of quality. Furthermore, in some implementations, the instructor feedback data can include contextual feedback relative to a portion of the learner solution. For example, the instructor feedback data can include an identification of a portion (e.g., a line, step, etc.) of the learner solution, feedback regarding whether the identified portion is accurate or inaccurate, and/or an explanation of the accuracy or inaccuracy. The instructor feedback data may additionally or alternatively include a corrected portion.

The training process can be repeated one or more times to iteratively and progressively improve the learner agent system with respect to the skillset. For example, in some implementations, subsequent to training the learner agent system based on the learner solution, systems and methods herein can provide for generating at least one second training task representative of the skillset. The second training task may be generated based on the performance of the learner agent system on the first training task. For example, if the learner solution was of a high quality or demonstrated improvement, the second training task may be relatively more complex than the first training task. If, however, the learner solution was of a relatively lower or inadequate quality or did not demonstrate improvement, the second training task may be of relatively similar complexity to the first training task.

Additionally and/or alternatively, after the learner agent system is trained, the learner agent system can be used at inference time to perform tasks using the skillset. For instance, example aspects of the present disclosure can additionally provide for, subsequent to training the learner agent system based on the learner solution, obtaining a request from a user to perform an inference task representative of the skillset and generating an output of the learner agent system by performing the inference task. The learner agent system can be enabled to perform the inference task based on training the learner agent system.

In one example implementation of aspects of the present disclosure, a first agent system that is generally trained for computer code generation can learn mathematics solving skills from one or more second agent systems that are generally trained for solving mathematics problems. For instance, it may be desirable to augment the functionality of the first agent system to perform mathematics problem solving to assist users of the first agent system in optimizing mathematically-based coding problems or because requests to the first agent system have demonstrated that a number of users have historically requested the first agent system to solve mathematics problems. The skillset of solving mathematics problems may invoke the selection of several training tasks, such as, for example, solving geometry problems, combinatorics problems, algebraic problems, arithmetic problems, calculus problems, and so on. Furthermore, it may be desirable to augment the first agent system to solve mathematics problems rather than configuring an additional agent system to solve mathematics problems. For example, this may avoid the requirement of training an additional agent system from scratch, distilling user preferences to the additional agent system, configuring a routing system to determine which agent to call for which task, and so on.

In another example implementation of aspects of the present disclosure, an agent system may be augmented to translate to a new language, such as a language that is increasingly used by a user. For example, a user may primarily speak a first language and may move to an area where a second language is predominantly spoken. The user may increasingly request the agent system to translate from the second language to the first language. While the agent system may utilize conventional translation techniques such as translation tools or other agent systems, example aspects of the present disclosure provide for the agent system to augment its capability to transmit between the two languages in a manner that provides significant benefits over existing systems. For example, the agent system can have reduced latency in translation compared to contacting a second agent system. Additionally, the agent system can be capable of translating even when offline. Furthermore, example aspects of the present disclosure can provide for the agent system to augment its translation capability without requiring that the agent system be entirely replaced with an agent system specifically trained for translation. In this manner, the present disclosure can provide for the agent system to preserve its understanding of the user and the preferences of the user (e.g., preserve its memory layer).

Example aspects of the present disclosure can provide a number of technical effects and benefits, including improvements to computing technology. As one example, the systems and methods according to example aspects of the present disclosure can provide for enabling new functionality of computing systems. For instance, example aspects of the present disclosure can provide for augmenting an existing artificial intelligence agent system with capabilities that the agent system is initially unable to perform. Furthermore, the increased capabilities can be provided without recreating or replacing the agent system with a different agent system, which can in turn provide for conserving customization and contextual understanding, such as user-specific understanding, in an existing agent system while augmenting the existing agent system with additional functionality. This, in turn, can provide for reduced usage of computing resources that would otherwise be dedicated to retraining a new agent system to restore the customizations or contextual understanding.

Additionally and/or alternatively, example aspects of the present disclosure can improve a number of additional computing-technology-specific fields, such as, for example, artificial intelligence agent system routing. By training a learner agent system to augment the learner agent system with additional functionality, the learner agent system can increase a number of tasks which it may itself handle. This, in turn, can provide for reducing the usage of computing resources, such as communication resources, which would otherwise be required for communicating with a second agent system to perform a task. Furthermore, the ability to handle more tasks locally can provide for improved security at the agent system, as tasks can be handled without sending communications to external agent systems.

Additionally and/or alternatively, example aspects of the present disclosure can improve the computing-technology-specific field of, for example, robotics control. As one example, an agent system can be taught as described herein to perform new or different control tasks without resetting the earlier-learned functionality of the agent system. For example, a first robotic control agent can be capable of performing a first manipulation task for controlling a robot. A manipulation task can include actuating or otherwise controlling various control systems of the robot to facilitate movement of the robot. In some cases, for example, the first robotic control agent may have learned to perform the first manipulation task over its operation such that it would be detrimental to use another agent system in place of the first robotic control agent. A second robotic control agent may be capable of performing a second manipulation task, but may or may not be capable of performing the first manipulation task. It can be desirable to teach the first robotic control agent to perform the second control task without retraining or replacing the first robotic control agent, and therefore preserving the capability of performing the first manipulation task. Example aspects of the present disclosure can provide for utilizing the first robotic control agent as the learner agent system and the second robotic control agent as the instructor agent system to teach the first robotic control agent to perform the second manipulation task.

Additionally and/or alternatively, example aspects of the present disclosure can improve the computing-technology-specific field of, for example, computer system control. For instance, the present disclosure can provide for improved capability of an agent system to control applications by simulating keyboard, mouse, or other control inputs. As one example, a learner agent system can be an agent system adapted for controlling web-native applications and the instructor agent system can be an agent system adapted for device-native applications, such as desktop-native applications or mobile-native applications. The learner agent system can adapt its behavior to better handle the differences in control schemes through the techniques described herein.

Various example implementations are described herein with respect to the accompanying FIGS.

### Example Agent Systems and Architectures

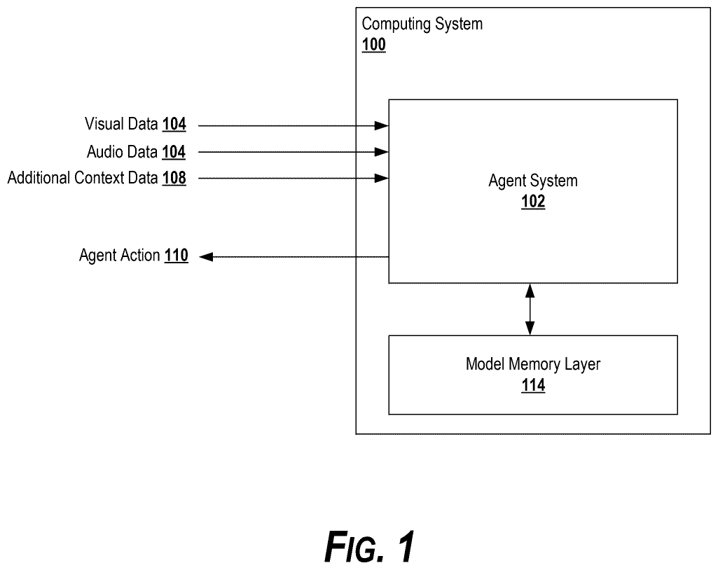

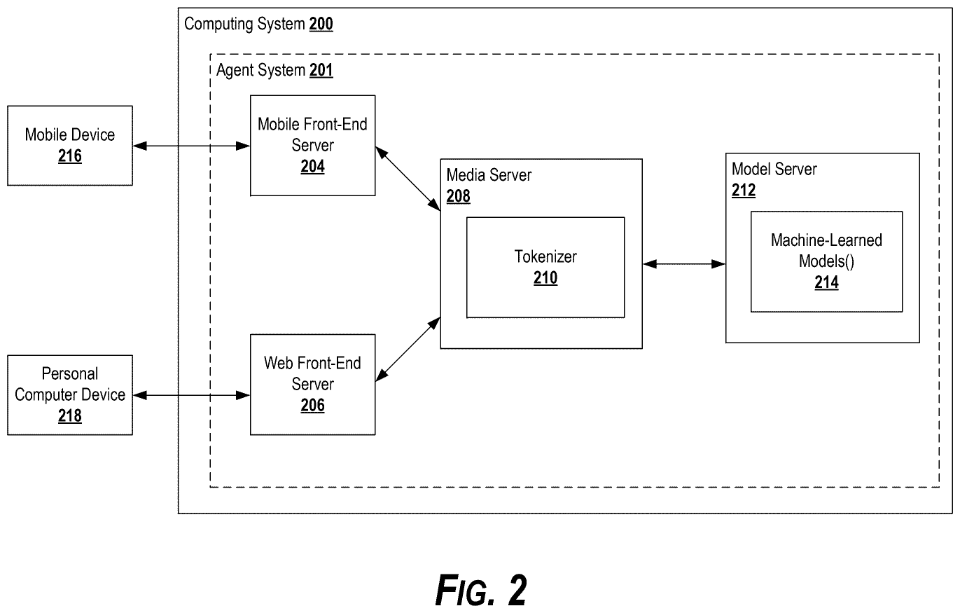

Referring now to FIG. 1, a block diagram illustrates an example computing system 100 configured to implement an agent system 102, according to example implementations of aspects of the present disclosure. The depicted computing system 100 is designed to receive multiple types of input data, process this data, and generate outputs that are responsive to the inputs in a contextually appropriate manner.

The agent system 102 within the computing system 100 is configured to receive visual data 104, audio data 106, and additional context data 108. Each type of data is processed by the agent system 102 to facilitate interaction within its operational environment. For example, visual data 104 can include live video streams from a camera or recorded video streams from a web resource, while audio data 106 can include spoken commands or ambient sounds captured by microphones.

Additional context data 108 can include sensor data, textual information, or other forms of digital data that provide further insights into the environment or the context of the interaction. As one example, the additional context data 108 can include sensor data that captures user inputs beyond speech inputs, such as touch-screen inputs, gestures, facial expressions, and/or other inputs. These user inputs can, in some implementations, be merged with other inputs such as visual data 104 to create combined inputs. In one example, a user can be provided with an interface that displays a real-time field of view of the agent system (e.g., which may correspond to visual data 104). The interface can enable the user to “draw” on or otherwise interact with the interface to mark up the real-time field of view. For example, the user could draw an arrow or make a circle to identify a particular object included within the scene displayed on the interface. The user's graphical input can be added onto or merged with the visual data 104 to form a combined input. For example, the visual data 104 can be amended to include the arrow or circle, which can then be processed by the agent system 102. In such manner, interactive interfaces can provide the ability for the user to more granularly interact with or identify portions of the environment when querying the agent system 102.

Furthermore, it should be appreciated that in some cases the user will be able to control the type, nature, content, or other characteristics of the visual data 104, audio data 106, and/or additional context data 108. As one example, the user can manipulate a field of view of a camera to alter the content of the visual data 104 that is provided to the agent system 102. Similarly, by speaking into a microphone, the user can provide additional audio data 106 as an input for the agent system 102. The agent system's ability to process and combine visual, auditory, and textual information allows it to generate more comprehensive and nuanced responses, carefully tailored to the user's multi-modal context.

The agent system 102 processes these diverse inputs to generate an agent action 110, which can include an output designed to respond to the processed inputs effectively. As examples, this action can range from textual responses, vocal responses, displaying information, controlling connected devices, or any other form of interaction output that is deemed appropriate based on the input data. Specifically, the agent system 102 can provide concise answers, generate detailed explanations, offer step-by-step instructions, display information through visual highlights or augmented reality overlays, control connected devices, and/or other forms of actions 110.

In some implementations, the agent system 102 can include and use specialized sequence processing models to integrate and analyze the input data. These models are configured to process complex patterns across different data modalities, enabling the agent system 102 to generate more accurate and contextually relevant responses. The sequence processing models may be specifically fine-tuned to handle various interaction dynamics, such as turn-based dialogues or more open-ended conversational formats, enhancing the flexibility and adaptability of the agent system.

Furthermore, the computing system 100 can be connected to a real-time communication framework that facilitates the immediate and efficient exchange of data, including the inputs and outputs to and from the agent system 102. This configuration reduces latency in data processing and response generation.

In some implementations, the agent system 102 can include or have access to a model memory layer 114 or other memory system. The agent system 102 can store and retrieve various types of information to and from the model memory layer 114. For example, the agent system 102 can store past interactions, observations, preferences, and/or information from the environment in the model memory layer 114. The agent system 102 can then recall this information for use in generating new predictions, outputs, or agent actions.

A number of different types of data can be stored in the model memory layer 114. One example of data stored within the model memory layer 114 can include object detections. This can include indexed records of objects that the agent system encounters during its operations, complete with metadata such as timestamps, location coordinates, and/or contextual tags. By archiving these detections, the agent system 102 can recognize and recall objects from a “history” of observed scenes. The agent system 102 can leverage this information to refine interactions and bolster situational awareness, potentially spanning different sessions of user interaction.

As another example data type, the model memory layer 114 can store embeddings of observed visual content, textual content, or other inputs. These embeddings can be low-dimensional numerical representations that encode the essential features of input data into a latent embedding space. The storage of embeddings associated with observed inputs allows the agent system 102 to conduct rapid comparisons and recognition tasks efficiently. In particular, these embeddings, which can be derived from various layer(s) of the agent system's machine-learned models, can be used to perform similarity searches to facilitate quick data retrieval.

As another example, intermediate model activations can be stored in the model memory layer 114. Capturing and preserving the state of model activations at various stages can enable the agent system 102 to efficiently resume or adjust its processing activities as needed. This feature can be used in scenarios involving long-running or complex processing tasks that may be interrupted or require dynamic adjustments such as resetting the agent system to a prior state associated with a prior time.

As another example, the model memory layer 114 can store raw tokens generated by the agent system's natural language processing, image processing, or other tokenization mechanisms. For example, a cache of tokens can be stored, with each being associated with a specific timestamp. This data allows for the reconstruction of the sequence of inputs and internal states over time, which can be used to retrieve and replay perceptual inputs associated with a particular timestamp or setting, or to otherwise provide the raw tokens as a contextual input for a later prediction.

By maintaining a repository of these data types, the agent system 102 can be equipped with a knowledge base that supports advanced functionalities such as context-aware computing, personalized interactions, and information retrieval from past observations. For example, upon retrieving stored information from the model memory layer 114, the agent system 102 can integrate the retrieved data into the current processing workflow. This integration can include aligning historical and current data to enhance the accuracy and relevance of the output.

In some implementations, the agent system 102 can include or have access to both short-term and long-term memory components. The short-term memory may be volatile, designed for the temporary storage of recent interactions and sensory inputs. In contrast, the long-term memory may be non-volatile, storing valuable learned information, user preferences, historical interaction data, and significant environmental events for longer-term recall and usage. In addition, the design of the model memory layer 114 can accommodate both structured and unstructured data. As an example, for immediate processing needs, volatile memory such as Random Access Memory (RAM) can be used. As another example, for the purpose of long-term data retention, non-volatile storage solutions such as Hard Disk Drives (HDDs) or Solid-State Drives (SSDs) can be used. Furthermore, the model memory layer 114 can include hybrid memory solutions that combine the rapid access capabilities of RAM with the extensive storage capacity of disk storage, thereby optimizing the performance of the agent system 102 across various tasks.

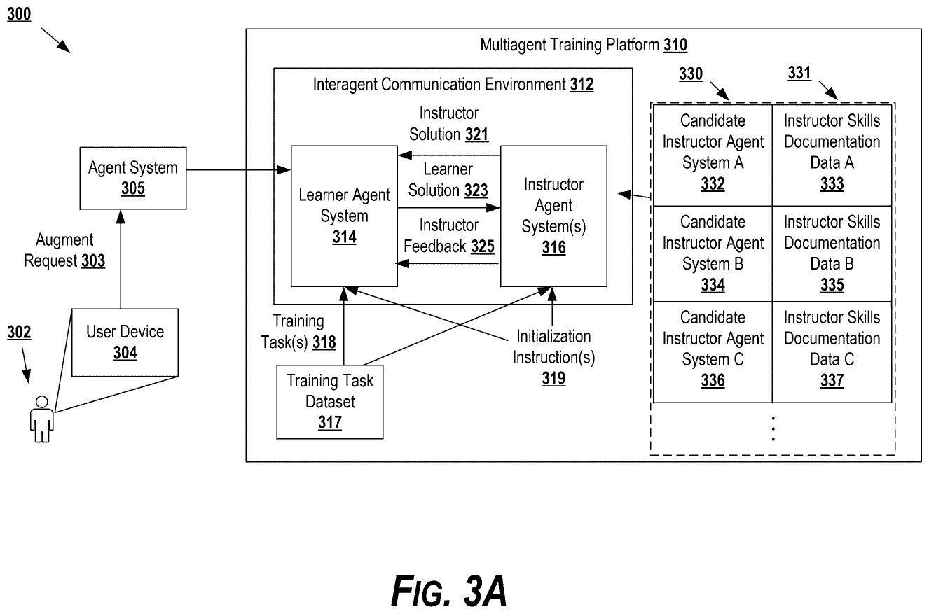

Referring now to FIG. 2, a block diagram illustrates an example computing system 200 configured to implement an agent system 201, according to example implementations of aspects of the present disclosure.

The agent system 201, which is implemented by the computing system 200, can be configured to interface with different types of client devices, including mobile device 216 and personal computer device 218. These devices can send and receive data to and from the agent system 201, allowing for a dynamic interaction between the user and the agent system.

The computing system 200 includes several components that facilitate the operation of the agent system 201. The mobile front-end server 204 and the web front-end server 206 represent the interfaces through which mobile and web-based interactions respectively occur. These servers manage the initial reception of input data from the mobile device 216 and the personal computer device 218, preprocessing this data as necessary before forwarding it to the media server 208.

The media server 208 can act as a central hub within the architecture, receiving processed inputs from both the mobile front-end server 204 and the web front-end server 206. One of the functions of the media server 208 can be to manage the flow of multimedia data, such as video and audio streams, which serve as inputs for the multi-modal capabilities of the agent system 201.

The media server 208 can include a tokenizer 210. The tokenizer 210 can operate to process the incoming multimedia data. For example, the tokenizer 210 breaks down complex data streams into manageable tokens, which are simpler data units that can be more easily processed by machine learning models.

From the media server 208, these tokens are then transmitted to the model server 212, which includes and runs one or more machine-learned models 214. These models 214 are responsible for analyzing the tokens to generate responses that are contextually-appropriate based on the input data. The model server 212 operates asynchronously with the tokenizer 210, ensuring that the tokenization process does not delay the response generation, thus maintaining low latency and high responsiveness of the agent system 201. Stated differently, the timing of the operations of the tokenizer 210 and the model server 212 can in general be established with less interdependence than if the operations of the tokenizer 210 and the model server 212 were sequentially performed by the same machine or machine cluster.

The architecture illustrated in FIG. 2 supports the efficient processing of data by decoupling the roles of front-end processing and model execution. This decoupling allows the system to optimize performance by parallelizing tasks and minimizing the processing time from input reception to response generation. The use of separate servers for handling different aspects of the data flow—front-end interaction, media processing, and model inference—enhances the system's ability to scale and manage large volumes of interactions simultaneously.

Furthermore, in some implementations, the mobile front-end server 204 and the web front-end server 206 can be specifically configured to support WebRTC protocols or other real-time communication frameworks. This configuration allows these servers to establish peer-to-peer connections with the client devices, facilitating direct data transfer paths that bypass traditional server relay methods. By using WebRTC, the system minimizes the latency typically associated with data transmission over the internet, enhancing the responsiveness of the agent system 201.

Additionally, the media server 208 can be equipped with specialized software components that handle the WebRTC streams. These components can include signal processing units that manage the real-time encoding and decoding of video and audio streams, ensuring that the data remains synchronized and maintains high quality throughout the transmission process. The integration of these components allows the media server 208 to efficiently manage the flow of multimedia data, preparing it for further processing by the tokenizer 210 and eventually the model server 212.

In the architecture illustrated in FIG. 2, the term “server” encompasses a broad range of configurations, each potentially include one or more machines. This includes setups where a server may represent a cluster of machines working collectively to handle specific tasks or workloads. Additionally, the machines involved in such configurations can be either physical machines, consisting of tangible hardware components, or virtual machines, which operate within a controlled software environment on a physical server.

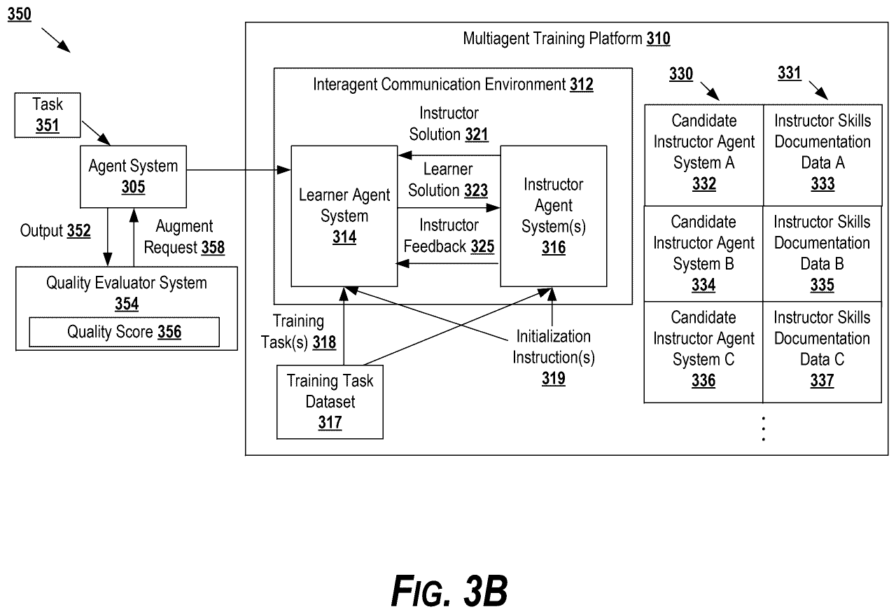

FIG. 3A illustrates a block diagram of an example system 300 according to example implementations of aspects of the present disclosure. The system 300 can include a user device 304. The user device 304 can be operated by a user 302. For instance, the user 302 can interact with the user device 304 to communicate with an agent system 305. For instance, the agent system 305 can be customized to the user 302. The user device 304 can interact with the agent system 305 over one or more networks (not illustrated). The user device 304 can be any suitable computing device, such as, for example, a mobile phone, a mobile computing device such as a laptop computer, a stationary computing device such as a desktop computer or server computing system, a wearable computing device such as those incorporated into smart watches or smart glasses, or other suitable computing device. The agent system 305 can be or can include any suitable agent system. For example, the agent system 305 can be an artificial intelligence (“AI”) agent. The agent system 305 can utilize machine-learned models and AI-enabled systems to help users solve tasks.

The agent system 305 can be augmented with additional functionality as described herein. In the example of FIG. 3A, for instance, the user device 304 can communicate an augment request 303 to the agent system 305. For example, in some implementations, the user 302 may provide a spoken, typed, or other mode of request to the agent system 305 (e.g., via the user device 304) asking the agent system 305 to augment its capabilities to assist the user 302 with some task. For example, the user 302 may provide a phrase or instruction as the augment request 303 to the agent system 305 such as “I'd like you to improve your ability to solve math problems” or “Can you improve at speaking Norwegian?” As another example, the request from a user may include some indication of negative feedback on a prior output of the agent system, such as a “thumbs down” reaction or other feedback indicative of dissatisfaction with the prior output. For example, the user 302 may provide a sentence such as “The agent should have been able to solve this mathematics problem” to request that the agent system be augmented to solve mathematics problems of a similar nature. The augment request 303 can include instructions that cause the agent system 305 to determine to augment itself with an additional skillset. For example, the augment request 303 can identify a skillset or type of problem that the user 302 desires for the agent system 305 to be augmented with.

To augment the skillset of the agent system 305, the agent system 305 can employ a multiagent training platform 310. The multiagent training platform 310 can be a platform for facilitating exchange, training, storage, and other communications between a plurality of agent systems for increasing availability of the agent systems. The multiagent training platform 310 can establish an interagent communication environment 312 for facilitating communications between a learner agent system 314 and one or more instructor agent system(s) 316 for improving the skillset of the learner agent system 314. The interagent communication environment 312 can be an environment that provides for one agent system (e.g., the learner agent system 314 or the instructor agent system(s) 316) to provide messages, context, and/or other inputs or outputs to another agent system. (e.g., the learner agent system 314 or the instructor agent system(s) 316) For example, the interagent communication environment 312 can be or can include a stack, input stream, or other manner of data exchange. The agent system 305 can be provided to the multiagent training platform as the learner agent system 314.

The multiagent training platform 310 can provide for obtaining at least one training task 318 representative of the skillset. The training task(s) 318 can be generated or otherwise sourced in any suitable manner. For instance, in some implementations, generating the at least one training task 318 can include generating the at least one training task 318 using the one or more instructor agent systems 316. For example, the instructor agent system(s) 316 can be prompted with a task generation request that instructs the instructor agent system(s) 316 to generate at least one training task 318. The training task(s) 318 may be generated relative to a particular difficulty or complexity within a domain of the skillset to account for the present skill of the learner agent system 314. Still further, in some implementations, the training task(s) 318 can be provided by or from a training task dataset 317. For instance, in some implementations, generating the at least one training task 318 can include accessing a training task dataset 317 including the at least one training task 318. The training tasks 318 may be indexed in the training task dataset 317 relative to various data such as, for example, task domain, skillset, difficulty, complexity, or other data.

In some implementations, the interagent communication environment 312 can be initialized to prime the learner agent system 314 and the instructor agent system(s) 316 for an instruction scenario. For instance, in some implementations, one or more initialization instructions 319 can be provided to the learner agent system 314 and/or the one or more instructor agent systems 316. The initialization instructions 319 can be any suitable instructions for assigning roles and/or establishing protocols to facilitate desired operation of the learner agent system and the instructor agent system(s). In some implementations, the one or more initialization instructions 319 can include one or more of an introductory instruction, a transfer learning instruction, a prior learning instruction, or a tool availability instruction. For instance, the introductory instruction may be a phrase such as “This is an environment established to facilitate learning <skillset>.” Additionally or alternatively, the transfer learning instruction can describe instructions on practices for transfer learning such as a phrase requesting that the models show a chain of thought. Additionally or alternatively, the prior learning instruction can describe some prior learning tasks, such as prior demonstrations or previous steps in a larger training curriculum. Additionally and/or alternatively, the tool availability instruction can describe which tools (e.g., a calculator, a search engine, etc.) can be used for learning.

The multiagent training platform 310 can select the instructor agent system(s) 316 used to instruct the learner agent system 314 from a pool of candidate instructor agent systems 330 associated with the multiagent training platform 310. The instructor agent system(s) 316 can be selected based on instructor skills documentation data 331 descriptive of respective skill capabilities of the candidate instructor agent systems 330. For example, in some implementations, selecting the one or more instructor agent systems 316 based on the instructor skills documentation data 331 can include matching the skillset to a capability specified by the instructor skills documentation data 331, and selecting the matching instructor agent system. For example, if a skillset is language translation in a particular language, an instructor agent system that is indicated by the instructor skills documentation data 331 as being capable in translating the particular language may be selected for instructing a learner agent system in translating the particular language.

For instance, once the skillset is identified, a system can configure an instruction scenario within the interagent communication environment 312 for the learner agent system 314 to be augmented with the skillset. The multiagent training platform 310 can generally select instructor agent systems 316 that are capable of and/or best at imparting the skillset to the learner agent system 314. In addition to the skillset, this selection process can account for other factors, such as the present capabilities of the learner agent system 314.

In some implementations, selecting the one or more instructor agent systems 316 can be based on instructor skills documentation data 331 that is indicative of an instruction quality of the candidate instructor agent systems 330. For instance, in some implementations, selecting the one or more instructor agent systems 316 can include obtaining instructor skills documentation data 331 indicative of an instruction quality of a plurality of candidate instructor agent systems 330 relative to the skillset. The plurality of candidate instructor agent systems 330 can be stored, referenced, or otherwise accessible or addressable by an instructor agent system repository or dataset that indexes the candidate instructor agent systems 330 relative to the instructor skills documentation data 331. For instance, in the example of FIG. 3A, a first candidate instructor agent system 332 is indexed relative to first instructor skills documentation data 333, a second candidate instructor agent system 334 is indexed relative to second instructor skills documentation data 335, a third candidate instructor agent system 336 is indexed relative to third instructor skills documentation data 337, and so on.

The instructor skills documentation data 331 can be any suitable data that is indicative of instruction quality. As one example, the instructor skills documentation data 331 can be or can include a quality score or other quality metric. The instructor skills documentation data 331 may include data corresponding to a particular task, skillset, task domain, or other suitable task descriptors. As another example, the instructor skills documentation data 331 can be or can include a description of some quality of the candidate instructor agent systems 330, such as a description of the capabilities of the candidate instructor agent systems 330. The description may include, for example, a plain language description (e.g., “this agent system is capable of solving polynomial equations”), metadata or tag-based descriptions (e.g., a “math-capable” tag associated with the candidate instructor agent system 330), or other suitable description. In some implementations, the instructor skills documentation data 331 can be generated based on historical training performance of the plurality of candidate instructor agent systems 330. For example, in a prior learning operation, a candidate instructor agent system 330 may be used to train some other learner agent system (e.g., in place of the learner agent system 314) on a particular skillset. The performance of the candidate instructor agent system 330 in the prior learning operation can be evaluated and used to generate the instructor skills documentation data 331 relative to the particular skillset. As another example, in some implementations, the candidate instructor agent systems 330 may be benchmarked and scored based on performance on a curriculum of tasks corresponding to a given skillset.

Additionally and/or alternatively, in some implementations, the instructor skills documentation data 331 can include self-identified capabilities from the plurality of candidate instructor agent systems 330. The self-identified capabilities can include data (e.g., text data, metadata, numerical data, etc.) that is provided by an agent system for describing a capability of the agent system. For example, to generate the self-identified capability data, a candidate instructor agent system 330 can be prompted with a capability description request, such as a message asking the candidate instructor agent system 330 to describe its capabilities. In response to the capability description request, the candidate instructor agent system 330 can respond with the self-identified capabilities, such as a scoring of its capabilities, a phrase describing its capabilities, or some other indication of domains in which the candidate instructor agent system 330 can produce a meaningful output.

Response to the training task(s) 318, in the example of FIG. 3A, the instructor agent system(s) 316 can generate an instructor solution 321. The instructor solution 321 can be a correct or valid solution to the at least one training task 318 due at least in part to the selection process of instructor agent system(s) 316. For example, by selecting instructor agent systems 316 based on instructor skills documentation data 331 indicating that the instructor agent systems 316 are capable of performing tasks in the domain of the training task(s) 318, the systems and methods herein can improve assurances that the instructor solution 321 represents a valid solution to the training task.

The instructor solution 321 can be provided to the learner agent system 314. For instance, the learner agent system 314 can consume the instructor solution 321 as input, context, or other data that affects its operation. Responsive to the instructor solution 321, the learner agent system can generate a learner solution 323 to the at least one training task 318. The learner solution 323 can represent an attempt by the learner agent system 314 to perform the training task(s) 318 after the instructor agent systems 316 have demonstrated valid performance of the training task 318 to the learner agent system 314. For instance, the learner solution 323 can represent an attempt by the learner agent system 314 to mirror performance of the skillset after it is demonstrated by the instructor solution 321.

The multiagent training platform 310 can provide for generating instructor feedback data 325 using the one or more instructor agent systems 316 and the at least one training task 318. The multiagent training platform 310 can then train the learner agent system 314 based on the instructor feedback data 325. The instructor feedback data 325 can be descriptive of a quality of the learner solution 323. For instance, the learner solution 323 can be used to produce a loss, feedback signal, or other suitable signal that can be used to modify one or more parameters of the learner agent system 314 to improve a capability level of the learner agent system 314 relative to the skillset. As one example, if the learner agent system 314 employs one or more machine-learned models, the parameters of the machine-learned models may be altered responsive to the learner agent system 314 to improve future predictions from the machine-learned models. As one example, training the learner agent system 314 based on the learner solution 323 can include assessing a quality of the learner solution 323 using the one or more instructor models and providing the learner agent system 314 with contextual feedback (e.g., in the form of instructor feedback data 325) based on the quality of the learner solution 323. The quality can be, for example, a quality score, such as a score reflective of an accuracy or other quality of the learner solution 323, a similarity score between the learner solution 323 and the instructor solution 321, or some other suitable data indicative of quality. Furthermore, in some implementations, the instructor feedback data 325 can include contextual feedback relative to a portion of the learner solution 323. For example, the instructor feedback data 325 can include an identification of a portion (e.g., a line, step, etc.) of the learner solution 323, feedback regarding whether the identified portion is accurate or inaccurate, and/or an explanation of the accuracy or inaccuracy. The instructor feedback data 325 may additionally or alternatively include a corrected portion.

Alternatively, in some implementations, the instructor feedback data 325 can include data from sources other than the instructor agent systems 316. For example, in some implementations, the task to be performed by the learner agent system 314 can be self-validating such that the task, or the environment in which the task is performed, provides adequate validation signals for verifying the performance of the learner agent system 314 without additional feedback from the instructor agent system(s) 316. As one example, if the task includes playing a game, the learner agent system may attempt to play the game and signals may be assessed from within the game itself (e.g., via a score or “level complete” flag). For instance, if the learner agent system successfully completes a level, it may be rewarded with a high score or successful progression to another level. The instructor agent system(s) 316 may be tasked with generating levels of the game as training tasks 318 but may not necessarily need to evaluate the performance of the learner agent system 314 directly. The levels may be generated by the instructor agent system(s) 316 with increasing difficulty as the performance of the learner agent system 314 improves. As another example, if the task includes generating code (e.g., computer code), the signals indicating successful code generation (that may be included within instructor feedback data 325) by the learner agent system 314 may include successful code compilation and/or execution, performance on benchmarks or test suites, or other external manners of assessing code quality.

FIG. 3B illustrates a block diagram of another example system 350 according to example implementations of aspects of the present disclosure. Components indicated using like reference numerals to FIG. 3A can be similar or identical to those components, except as otherwise indicated. In the example of FIG. 3B, rather than receiving an augment request 303 from a user 302, an augment request 358 is received by the agent system 305 based on an inadequate quality of an output 352. In particular, the agent system 305 can generate an output 352 responsive to a task 351. The task 351 can be any suitable task, including a task from a user. The agent system 305 may not generally be capable of performing the task 351. For example, the agent system 305 may generate an output 352 stating that it is incapable of performing the task based on a self-evaluation and/or may generate a nonsensical output 352.

A quality evaluator system 354 can obtain the output 352 and assess a quality score 356 associated with the output 352. The quality evaluator system 354 can further determine that the quality score 356 of the output 352 is within an inadequate prediction quality score range (and/or determine that the quality score 356 of the output 352 is not within an adequate prediction quality score range). The prediction quality score range can be a range of values that indicates acceptable or unacceptable quality in the output 352. Upon determining that the output 352 is inadequate, the quality evaluator system 354 can communicate an augment request 358 to the agent system 305 instructing the agent system 305 to augment its skillset such that it can perform the task 351.

### Example Methods

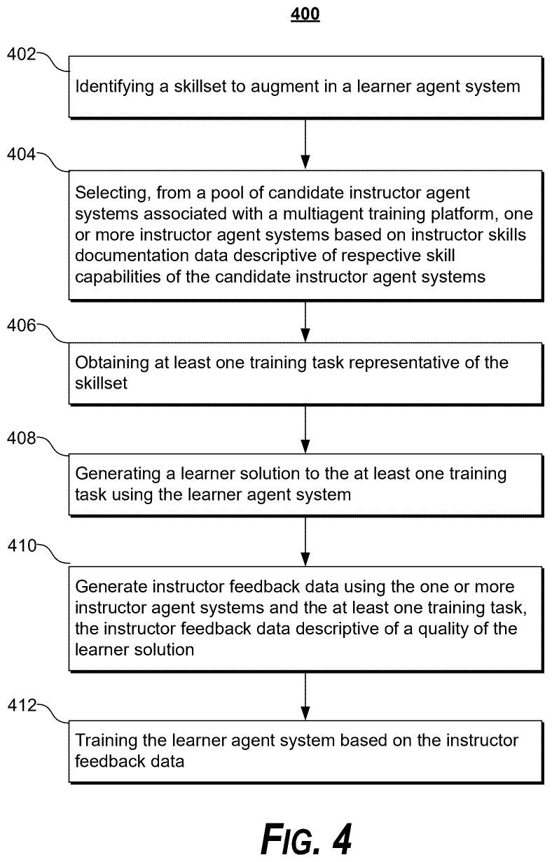

FIG. 4 depicts one example method 400 for skillset augmentation of artificial intelligence agents. Each respective portion of example method 400 can be performed by any (or any combination) of one or more computing devices. Moreover, one or more portion(s) of example method 400 can be implemented on the hardware components of the device(s) described herein, for example, to train one or more systems or models. FIG. 4 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 4 is described with reference to elements/terms described with respect to other systems and figures for exemplary illustrated purposes and is not meant to be limiting. One or more portions of example method 400 can be performed additionally, or alternatively, by other systems.

The method 400 includes, at 402, identifying a skillset to augment in a learner agent system. The learner agent system can be any suitable agent system, such as an artificial intelligence (AI) agent system or “AI agent.” The identification of a skillset to augment in a learner agent system can occur in a variety of approaches. For instance, in some implementations, identifying the skillset can include determining to augment the learner agent system with the skillset. For instance, a user of the agent system, the agent system itself, and/or another component in a larger system implementing or operating the agent system can recognize a need, benefit, or other motivation to augment the learner agent system with the skillset to improve performance of the learner agent system during its operation.

In some implementations, the agent can be implemented as a “situated agent”. The term situated agent refers to a setting in which the agent shares one or more perceptual inputs with a human user. For example, the situated agent can receive and process various data inputs, including video, audio, and/or textual data which are also observable by the human user. The agent can process these inputs to generate responses that are contextually relevant for the user's physical or digital environment, for example enabling the agent to generate dialogue or other responses or outputs which assist the user in understanding and/or navigating the environment.

According to one aspect of the present disclosure, some example implementations of the artificial intelligence agent can include or leverage sequence processing models to effectively process and respond to user interactions. For example, these models, such as large language models (LLMs) and large-multimodal models (LMMs), can process a wide range of input data types, including textual, audio, and/or visual data. By integrating these diverse data types, the agent can generate more contextually relevant responses that are configured to the specific situation and environment of the user.

Some artificial intelligence agents may include or have access to a memory layer that enables the storage and retrieval of various types of information associated with historical usage of the artificial intelligence agents. This can include past interactions, observations, preferences, and/or environmental data. The agent can utilize this stored information to generate new predictions, outputs, or actions, effectively using historical data to inform and improve its real-time responses and decision-making processes.

As one example, in some implementations, determining to augment the learner agent system with the skillset can include determining an inadequate prediction quality of the learner agent system on the skillset. The inadequate prediction quality can signal that the learner agent system is incapable of performing tasks requiring the skillset and/or otherwise provides undesirable outputs (e.g., incorrect or low-confidence outputs) when performing the tasks requiring the skillset. The inadequate prediction quality condition can occur in response to an output of the learner agent system when performing a task. For example, in some implementations, determining the inadequate prediction quality of the learner agent system of the skillset can include generating an output of the learner agent system by performing a task representative of the skillset and determining that a quality score of the output is within an inadequate prediction quality score range. Additionally and/or alternatively, determining the inadequate prediction quality of the learner agent system of the skillset may include determining that a quality score of the output is not within an adequate prediction quality score range. The prediction quality score range can be a range of values that indicates acceptable or unacceptable quality in the output. For instance, in some implementations, the agent system itself, another agent system, and/or an evaluation model may be configured to assess or critique the outputs from the agent system to determine whether the outputs are useful, correct, or otherwise desirable or undesirable. In some cases, determining to augment the learner agent system with the skillset may occur if a single output is inadequate. Still further, in some implementations, the determination to augment the learner agent system may be made after a number of inadequate outputs, such as a certain frequency or number of inadequate outputs over a given period of time.

Additionally and/or alternatively, in some implementations, determining to augment the learner agent system with the skillset can include receiving a request from a user to augment the learner agent system with the skillset. For example, in some implementations, the user may provide a spoken, typed, or other mode of request to the agent system asking the agent system to augment its capabilities to assist the user with some task. For example, the user may provide a sentence such as “the agent should have been able to solve this mathematics problem” to request that the agent system be augmented to solve mathematics problems of a similar nature. As another example, the request from a user may include some indication of negative feedback on a prior output of the agent system, such as a “thumbs down” reaction or other feedback indicative of dissatisfaction with the prior output.

The method 400 can include, at 404, selecting, from a pool of candidate instructor agent systems associated with a multiagent training platform, one or more instructor agent systems based on instructor skills documentation data descriptive of respective skill capabilities of the candidate instructor agent systems. For example, in some implementations, selecting the one or more instructor agent systems based on the instructor skills documentation data can include matching the skillset to a capability specified by the instructor skills documentation data, and selecting the matching instructor agent system. For example, if a skillset is language translation in a particular language, an instructor agent system that is indicated by the instructor skills documentation data as being capable in translating the particular language may be selected for instructing a learner agent system in translating the particular language.

The multiagent training platform can be a platform for facilitating exchange, training, storage, and other communications between a plurality of agent systems for increasing availability of the agent systems. For instance, once the skillset is identified, a system can configure an instruction scenario for the agent system to be augmented with the skillset. This skillset can be imparted on the agent system through a sort of “gym” or “classroom” setting involving the interaction of the learner agent system with one or more instructor agent systems. For instance, systems and methods according to the present disclosure can provide for selecting one or more instructor agent systems based on the skillset.

The systems and methods can generally select instructor agent systems that are capable of and/or best at imparting the skillset to the learner agent system. In addition to the skillset, this selection process can account for other factors, such as the present capabilities of the learner agent system. For instance, in a similar manner to how a human student may struggle to understand advanced mathematics without a strong foundational understanding of arithmetic, an agent system may first learn to perform a relatively basic task in a given domain before the agent system can efficiently learn to perform more advanced tasks. Two instructor agent systems that are capable of instructing in a common domain may nonetheless be more or less efficient at instructing for particular levels or tasks within that domain. The systems and methods herein can account for the capabilities of instructor agent systems to instruct at a given level, type of task, or other differentiation within a problem domain.

In some implementations, selecting the one or more instructor agent systems can be based on instructor skills documentation data that is indicative of an instruction quality of the instructor agent systems. For instance, in some implementations, selecting the one or more instructor agent systems can include obtaining instructor skills documentation data indicative of an instruction quality of a plurality of candidate instructor agent systems relative to the skillset. The plurality of candidate instructor agent systems can be stored, referenced, or otherwise accessible or addressable by an instructor agent system repository or dataset that indexes the candidate instructor agent systems relative to the instructor skills documentation data.

The instructor skills documentation data can be any suitable data that is indicative of instruction quality. As one example, the instructor skills documentation data can be or can include a quality score or other quality metric. The instructor skills documentation data may include data corresponding to a particular task, skillset, task domain, or other suitable task descriptors. As another example, the instructor skills documentation data can be or can include a description of some quality of the instructor agent systems, such as a description of the capabilities of instructor agent systems. The description may include, for example, a plain language description (e.g., “this agent system is capable of solving polynomial equations”), metadata or tag-based descriptions (e.g., a “math-capable” tag associated with the instructor agent system), or other suitable description. In some implementations, the instructor skills documentation data can be generated based on historical training performance of the plurality of candidate instructor agent systems. For example, in a prior learning operation, a candidate instructor agent system may be used to train some other learner agent system on a particular skillset. The performance of the candidate instructor agent system in the prior learning operation can be evaluated and used to generate the instructor skills documentation data relative to the particular skillset. As another example, in some implementations, the candidate instructor agent systems may be benchmarked and scored based on performance on a curriculum of tasks corresponding to a given skillset.

Additionally and/or alternatively, in some implementations, the instructor skills documentation data can include self-identified capabilities from the plurality of candidate instructor agent systems. The self-identified capabilities can include data (e.g., text data, metadata, numerical data, etc.) that is provided by an agent system for describing a capability of the agent system. For example, to generate the self-identified capability data, a candidate instructor agent system can be prompted with a capability description request, such as a message asking the instructor agent system to describe its capabilities. In response to the capability description request, the candidate instructor agent system can respond with the self-identified capabilities, such as a scoring of its capabilities, a phrase describing its capabilities, or some other indication of domains in which the candidate instructor agent system can produce a meaningful output.

The method 400 can include at 406, obtaining at least one training task representative of the skillset. The training tasks can be generated or otherwise sourced in any suitable manner. For instance, in some implementations, generating the at least one training task can include generating the at least one training task using the one or more instructor agent systems. For example, the instructor agent systems can be prompted with a task generation request that instructs the instructor agent systems to generate a task. The task may be generated relative to a particular difficulty or complexity within a domain of the skillset to account for the present skill of the learner agent system. For instance, in some implementations, generating the at least one training task using the one or more instructor agent systems can include evaluating a performance capability of the learner agent system on the skillset and generating, using the one or more instructor agent systems, the at least one training task based on the performance capability of the learner agent system on the skillset. The performance capability of the learner agent system can be or can include a score, evaluation, or other indication of how skilled the learner agent system is and/or what level of difficulty or complexity of tasks the learner agent system is capable of adequately performing. Still further, in some implementations, the training tasks can be provided by a training task dataset or other repository of training tasks. For instance, in some implementations, generating the at least one training task can include accessing a training task dataset including the at least one training task. The training tasks may be indexed in the training task dataset relative to various data such as, for example, task domain, skillset, difficulty, complexity, or other data.

The method 400 can include, at 408, generating a learner solution to the at least one training task using the learner agent system. The learner solution can represent an attempt by the learner agent system to perform the training task after the instructor agent systems have demonstrated valid performance of the training task to the learner agent system. For instance, the learner solution can represent an attempt by the learner agent system to mirror performance of the skillset after it is demonstrated by the instructor solution.

Additionally and/or alternatively, systems and methods according to the present disclosure can provide for, in some implementations, generating an instructor solution to the at least one training task using the one or more instructor agent systems. The instructor solution can be a correct or valid solution to the at least one training task due at least in part to the selection process of instructor agent systems. For example, by selecting instructor agent systems based on instructor skills documentation data indicating that the instructor agent systems are capable of performing tasks in the domain of the training task, the systems and methods herein can improve assurances that the instructor solution represents a valid solution to the training task. The instructor solution may not only include an ultimate answer or response to the training task, but in some implementations may additionally describe a “chain-of-thought” or step-by-step walkthrough of the solution. For instance, a higher-level task can be decomposed into a sequence of relatively simpler tasks that may be solved more trivially. For example, in a mathematics problem, the instructor solution may illustrate a progression of relatively simpler operations starting at the problem itself and progressing toward the ultimate answer. As another example, in a language translation task, the instructor solution may illustrate how various grammatical, word choice, or other linguistic rules or exceptions shape the translation. To prompt the instructor agent systems to provide a progressive solution to the training task, the instructor agent systems may be operated using self-reflection, chain-of-thought prompting, refinement, or other approaches that cause the instructor agent systems to generate progressive outputs.

Additionally and/or alternatively, systems and methods according to the present disclosure can provide for providing the instructor solution to the learner agent system. For instance, the learner agent system can consume the instructor solution as input, context, or other data that affects its operation. Responsive to the instructor solution, the learner agent system can generate the learner solution to the at least one training task.

Furthermore, in some implementations, the instructor solution can include progress data indicative of a progress toward a final value at each stage of the instructor solution. The progress data can be, for example, a percentage or other indication of relative progress through the instructor solution at each stage. For example, a halfway point in the instructor solution may be labeled with some metadata or otherwise indicate that the learner agent is halfway done with the task if it is able to successfully recreate the instructor solution to that point. This progress data can serve as a signal that provides for the agent systems to focus their instruction and learning on portions of the solution where the learner agent struggles.

In some implementations, to facilitate exchange of communications and solutions between the learner agent system and the instructor agent system(s), the learner agent system and the one or more instructor agent systems can be provided in an interagent communication environment (e.g., of the multiagent training platform). The interagent communication environment can be an environment that provides for one agent system to provide messages, context, and/or other inputs or outputs to another agent system. For example, the interagent communication environment can be or can include a stack, input stream, or other manner of data exchange. In particular, providing the instructor solution to the learner agent system can be performed via the interagent communication environment.

In some implementations, the interagent communication environment can be initialized to prime the learner agent system and the instructor agent system(s) for an instruction scenario. For instance, in some implementations, providing the learner agent system and the one or more instructor agent systems in the interagent communication environment can include establishing communication between the learner agent system and the one or more instructor agent systems and providing one or more initialization instructions to the learner agent system and the one or more instructor agent systems. The initialization instructions can be any suitable instructions for assigning roles and/or establishing protocols to facilitate desired operation of the learner agent system and the instructor agent system(s). In some implementations, the one or more initialization instructions comprise one or more of an introductory instruction, a transfer learning instruction, a prior learning instruction, or a tool availability instruction. For instance, the introductory instruction may be a phrase such as “This is an environment established to facilitate learning <skillset>.” Additionally or alternatively, the transfer learning instruction can describe instructions on practices for transfer learning such as a phrase requesting that the models show a chain of thought. Additionally or alternatively, the prior learning instruction can describe some prior learning tasks, such as prior demonstrations or previous steps in a larger training curriculum. Additionally and/or alternatively, the tool availability instruction can describe which tools (e.g., a calculator, a search engine, etc.) can be used for learning.

The method 400 can include, at 410, generating instructor feedback data using the one or more instructor agent systems and the at least one training task. Furthermore, at 412, the method 400 can include training the learner agent system based on the instructor feedback data. The instructor feedback data can be descriptive of a quality of the learner solution. For instance, the learner solution can be used to produce a loss, feedback signal, or other suitable signal that can be used to modify one or more parameters of the learner agent system to improve a capability level of the learner agent system relative to the skillset. As one example, if the learner agent system employs one or more machine-learned models, the parameters of the machine-learned models may be altered responsive to the learner agent system to improve future predictions from the machine-learned models. As one example, training the learner agent system based on the learner solution can include assessing a quality of the learner solution using the one or more instructor models and providing the learner agent system with contextual feedback based on the quality of the learner solution. The quality can be, for example, a quality score, such as a score reflective of an accuracy or other quality of the learner solution, a similarity score between the learner solution and the instructor solution, or some other suitable data indicative of quality. Furthermore, in some implementations, the instructor feedback data can include contextual feedback relative to a portion of the learner solution. For example, the instructor feedback data can include an identification of a portion (e.g., a line, step, etc.) of the learner solution, feedback regarding whether the identified portion is accurate or inaccurate, and/or an explanation of the accuracy or inaccuracy. The instructor feedback data may additionally or alternatively include a corrected portion.

The training process can be repeated one or more times to iteratively and progressively improve the learner agent system with respect to the skillset. For example, in some implementations, subsequent to training the learner agent system based on the learner solution, systems and methods herein can provide for generating at least one second training task representative of the skillset. The second training task may be generated based on the performance of the learner agent system on the first training task. For example, if the learner solution was of a high quality or demonstrated improvement, the second training task may be relatively more complex than the first training task. If, however, the learner solution was of a relatively lower or inadequate quality or did not demonstrate improvement, the second training task may be of relatively similar complexity to the first training task.

Additionally and/or alternatively, after the learner agent system is trained, the learner agent system can be used at inference time to perform tasks using the skillset. For instance, example aspects of the present disclosure can additionally provide for, subsequent to training the learner agent system based on the learner solution, obtaining a request from a user to perform an inference task representative of the skillset and generating an output of the learner agent system by performing the inference task. The learner agent system can be enabled to perform the inference task based on training the learner agent system.

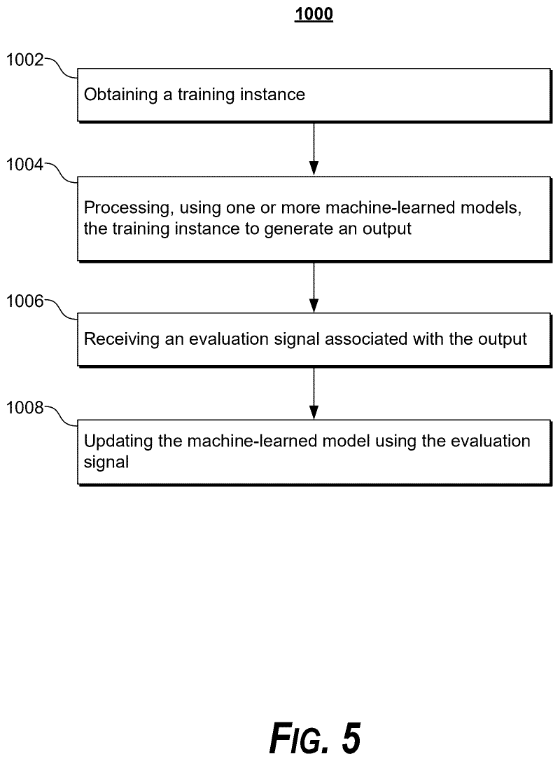

FIG. 5 depicts a flowchart of a method 1000 for training one or more machine-learned models according to aspects of the present disclosure. For instance, an example machine-learned model can include a sequence processing model.

One or more portion(s) of example method 1000 can be implemented by a computing system that includes one or more computing devices such as, for example, computing systems described with reference to the other figures. Each respective portion of example method 1000 can be performed by any (or any combination) of one or more computing devices. Moreover, one or more portion(s) of example method 1000 can be implemented on the hardware components of the device(s) described herein, for example, to train one or more systems or models. FIG. 5 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 5 is described with reference to elements/terms described with respect to other systems and figures for exemplary illustrated purposes and is not meant to be limiting. One or more portions of example method 1000 can be performed additionally, or alternatively, by other systems.

At 1002, example method 1000 can include obtaining a training instance. A set of training data can include a plurality of training instances divided between multiple datasets (e.g., a training dataset, a validation dataset, or testing dataset). A training instance can be labeled or unlabeled. Although referred to in example method 1000 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 1004, example method 1000 can include processing, using one or more machine-learned models, the training instance to generate an output. The output can be directly obtained from the one or more machine-learned models or can be a downstream result of a chain of processing operations that includes an output of the one or more machine-learned models.

At 1006, example method 1000 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi-or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 1008, example method 1000 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 1000 can include implementing a number of generalization techniques (e.g., weight decays, dropouts, etc.) to improve the generalization capability of the models being trained.

In some implementations, example method 1000 can be implemented for training a machine-learned model from an initialized state to a fully trained state (e.g., when the model exhibits a desired performance profile, such as based on accuracy, precision, recall, etc.).

In some implementations, example method 1000 can be implemented for particular stages of a training procedure. For instance, in some implementations, example method 1000 can be implemented for pre-training a machine-learned model. Pre-training can include, for instance, large-scale training over potentially noisy data to achieve a broad base of performance levels across a variety of tasks/data types. In some implementations, example method 1000 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

### Example Machine-Learned Models

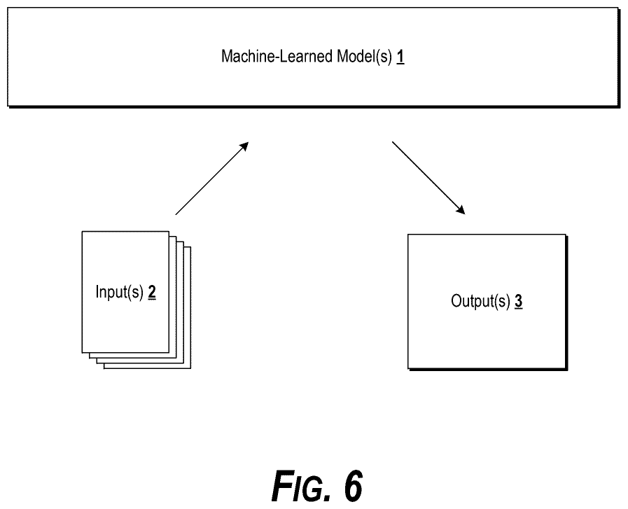

FIG. 6 is a block diagram of an example processing flow for using machine-learned model(s) 1 to process input(s) 2 to generate output(s) 3.

Machine-learned model(s) 1 can be or include one or multiple machine-learned models or model components. The machine-learned model(s) 1 can be or can include, for example, the machine-learned model(s) 214 models employed by agent system(s) 102, 201, 304, 314 and/or 316 of FIGS. 1-3 . Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models. For example, the machine-learned models can be or include transformer models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV: 2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

### Example Machine-Learned Sequence Processing Models

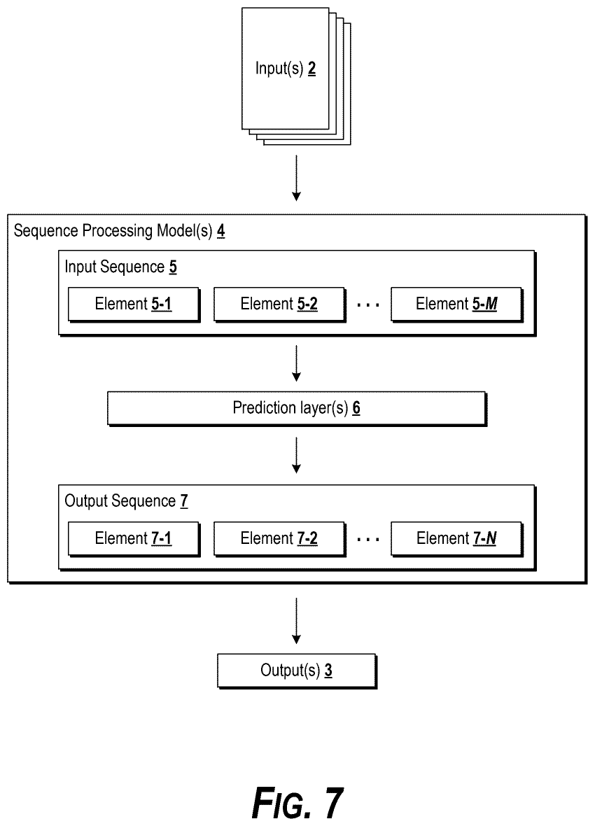

FIG. 7 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV: 2010.11929v2 (Jun. 3, 2021), audio domains, see, e.g., Agostinelli et al., MusicLM: Generating Music From Text, ARXIV: 2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . 5-M can represent tokens obtained using a tokenizer. For instance, a tokenizer can process a given portion of an input source and output a series of tokens (e.g., corresponding to input elements 5-1, 5-2, . . . 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image. Other tokenization approaches can be performed as well, including linear projections, non-linear transformations, and/or other data transformations.

In general, arbitrary data types can be serialized and processed into input sequence 5. It is to be understood that element(s) 5-1, 5-2, . . . 5-M depicted in FIG. 7 can be the tokens or can be the embedded representations thereof.

Prediction layer(s) 6 can predict one or more output elements 7-1, 7-2, . . . 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ___.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV: 1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via an input sequence 5.

Output sequence 7 can be generated autoregressively. For instance, for some applications, an output of one or more prediction layer(s) 6 can be passed through one or more output layers (e.g., SoftMax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV: 2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

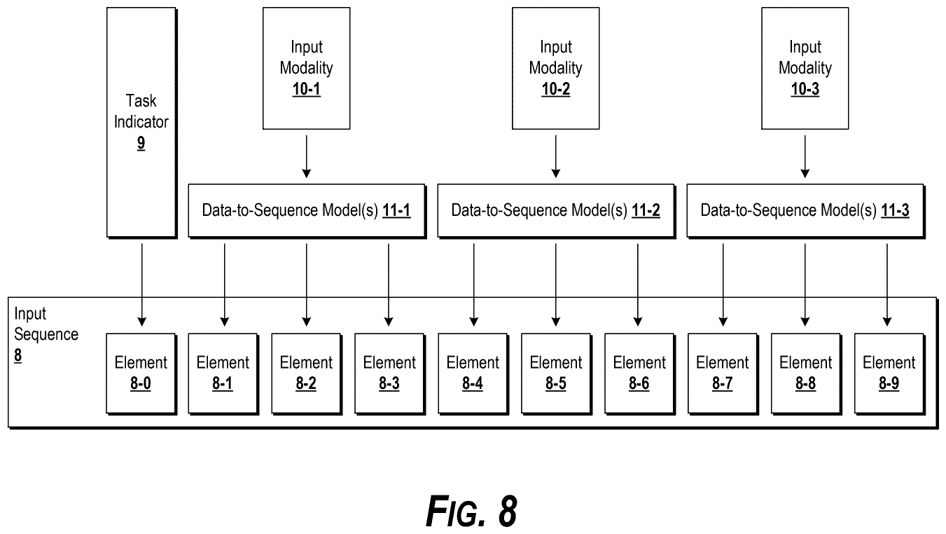

FIG. 8 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

### Example Machine-Learned Model Development Platform

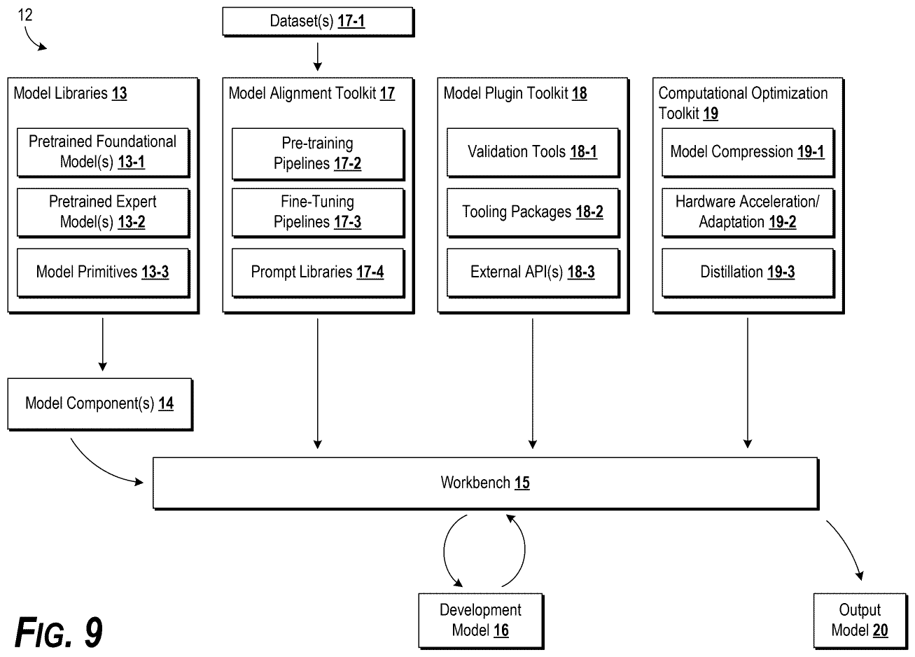

FIG. 9 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 1000 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. As another example, a tool can have a machine-learned model with reduced model overhead compared to a larger machine-learned model. For instance, the model of the tool can be a less sophisticated model than the calling model that is specialized to a particular task or subset of tasks and can require fewer computing resources to produce a usable output. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem or for evaluation of simpler tasks that can be adequately performed by a less sophisticated model.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”). One example tool that can be included in validation tools 18-1 is a routing tool for routing a query from a user to a user-specific memory layer or a public data interface.

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems. As an example, the development model 16 can initiate API calls to one or more public data interface(s) to send or obtain data from one or more public data sources, such as webpages, databases, and so on.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

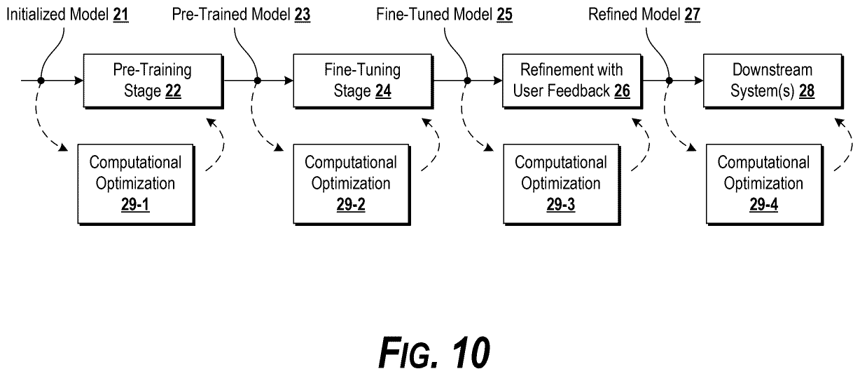

FIG. 10 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 10 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 10 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . 29-4 can all be the same, all be different, or include at least some different optimization techniques.

### Example Machine-Learned Model Inference System

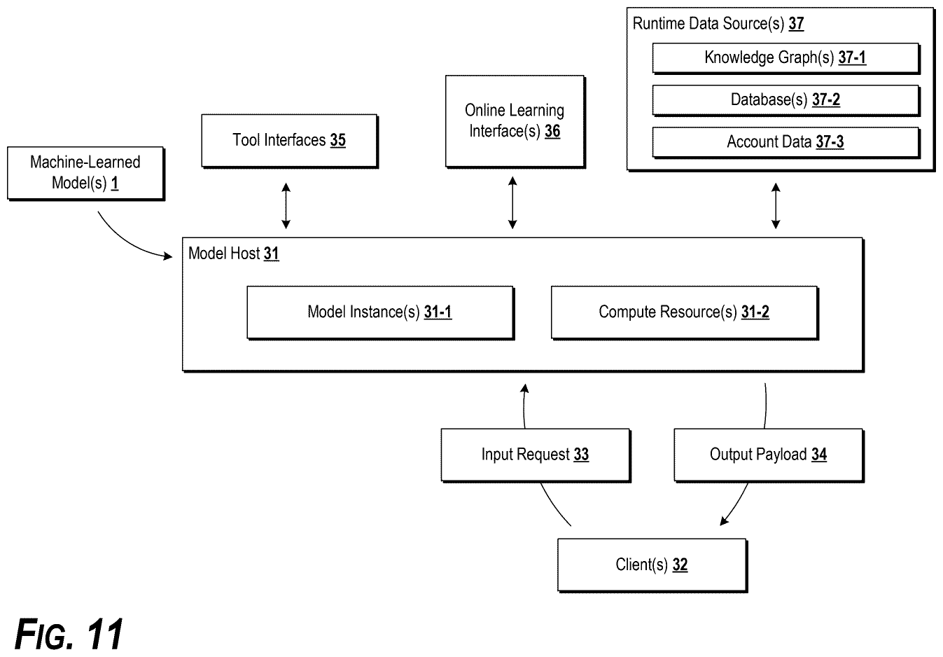

FIG. 11 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored on or in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model can generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task can be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task can be an audio compression task. The input can include audio data and the output can be or can include compressed audio data. In another example, the input includes visual data (e.g. one or more images or videos), the output includes compressed visual data, and the task is a visual data compression task. In another example, the task can include generating an embedding for input data (e.g. input audio or visual data). In some cases, the input includes audio data representing a spoken utterance and the task is a speech recognition task. The output can be or can include a text output which is mapped to the spoken utterance. In some cases, the task includes encrypting or decrypting input data. In some cases, the task includes a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

### Example Computing Systems and Devices

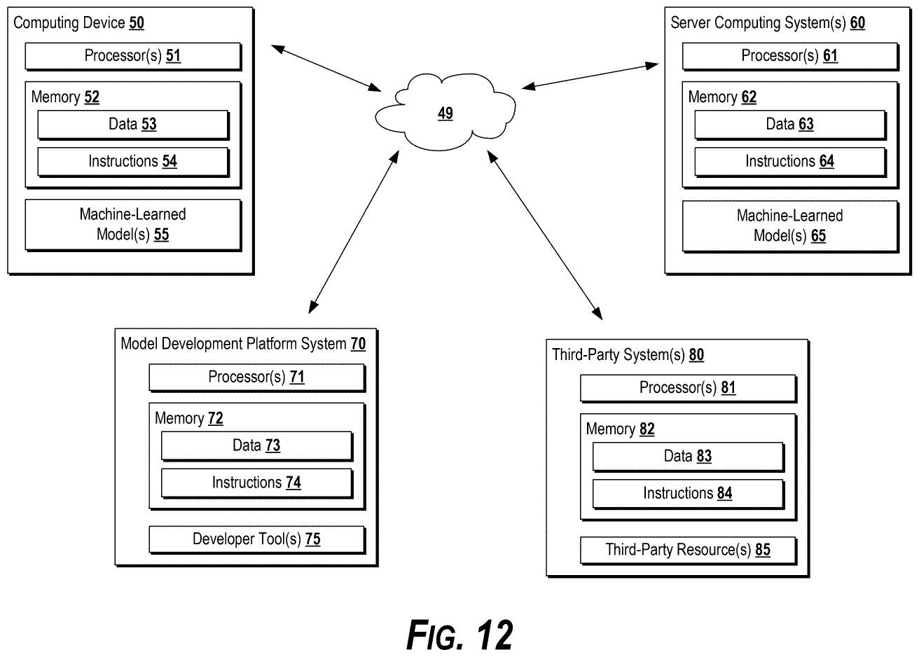

FIG. 12 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 12 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who can use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 12 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

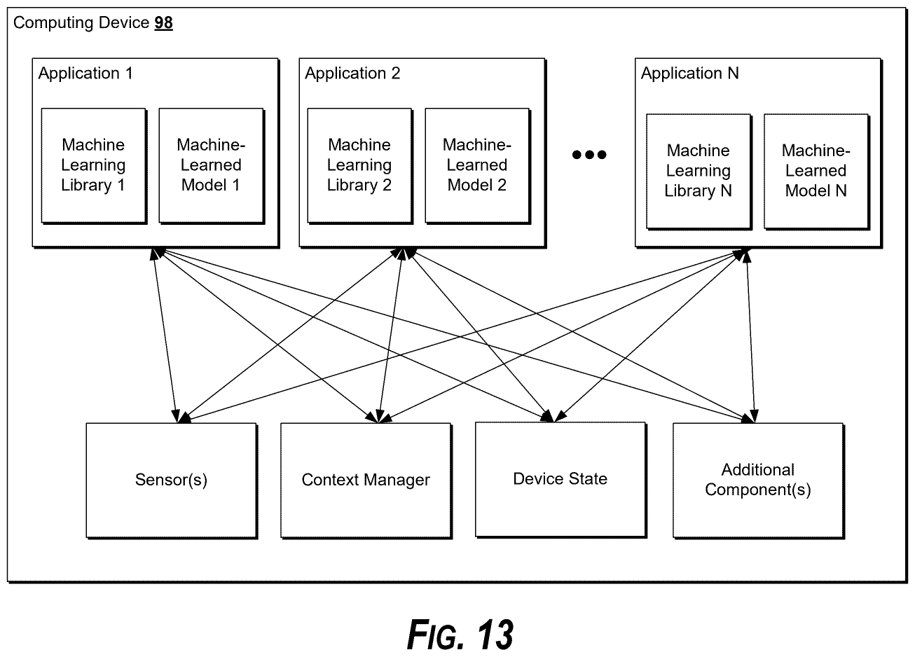

FIG. 13 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 13, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

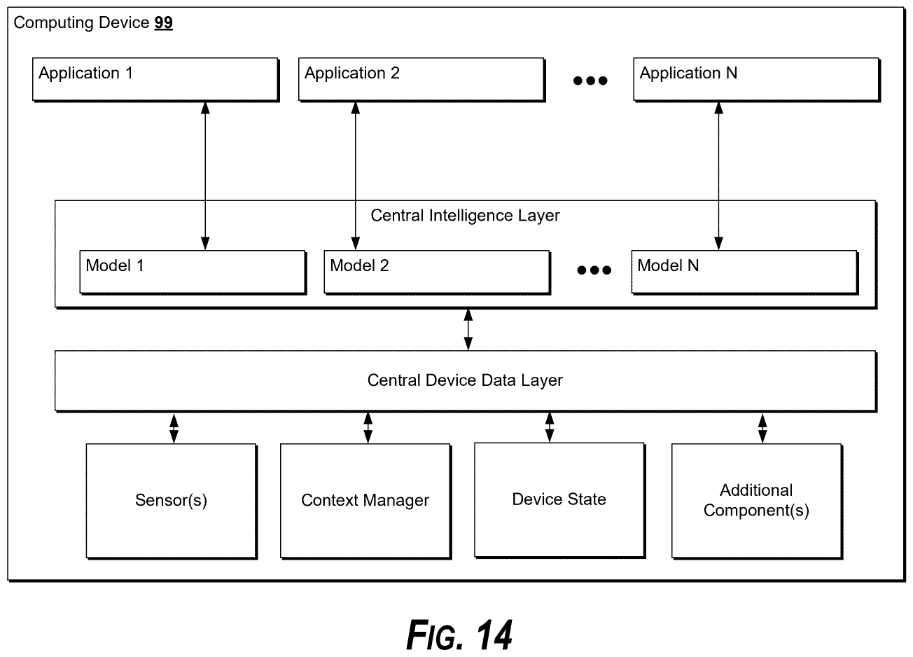

FIG. 14 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 14, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 14, the central device data layer can communicate with a number of other components of the computing device, such as, for example, one or more sensors, a context manager, a device state component, or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method, comprising:
identifying a skillset to augment in a learner agent system;
selecting, from a pool of candidate instructor agent systems associated with a multiagent training platform, one or more instructor agent systems based on instructor skills documentation data descriptive of respective skill capabilities of the candidate instructor agent systems;
obtaining at least one training task representative of the skillset;
generating a learner solution to the at least one training task using the learner agent system;
generating instructor feedback data using the one or more instructor agent systems and the at least one training task, the instructor feedback data descriptive of a quality of the learner solution; and
training the learner agent system based on the instructor feedback data.

2. The computer-implemented method of claim 1, wherein identifying the skillset comprises determining to augment the learner agent system with the skillset.

3. The computer-implemented method of claim 2, wherein determining to augment the learner agent system with the skillset comprises determining an inadequate prediction quality of the learner agent system on the skillset.

4. The computer-implemented method of claim 3, wherein determining the inadequate prediction quality of the learner agent system of the skillset comprises:
generating an output of the learner agent system by performing a task representative of the skillset; and
determining that a quality score of the output is within an inadequate prediction quality score range.

5. The computer-implemented method of claim 2, wherein determining to augment the learner agent system with the skillset comprises receiving an augment request from a user indicating to augment the learner agent system with the skillset.

6. The computer-implemented method of claim 1, wherein the instructor skills documentation data is generated based on historical training performance of the pool of candidate instructor agent systems.

7. The computer-implemented method of claim 1, wherein the instructor skills documentation data comprises self-identified skill capabilities from the pool of candidate instructor agent systems.

8. The computer-implemented method of claim 1, further comprising:
generating an instructor solution to the at least one training task using the one or more instructor agent systems;
providing the instructor solution to the learner agent system; and
responsive to the instructor solution, generating the learner solution to the at least one training task.

9. The computer-implemented method of claim 8, wherein the instructor solution comprises progress data indicative of a progress toward a final value at each stage of the instructor solution.

10. The computer-implemented method of claim 8, further comprising:
providing the learner agent system and the one or more instructor agent systems in an interagent communication environment of the multiagent training platform; and
wherein providing the instructor solution to the learner agent system is performed via the interagent communication environment.

11. The computer-implemented method of claim 10, wherein providing the learner agent system and the one or more instructor agent systems in the interagent communication environment comprises:
establishing communication between the learner agent system and the one or more instructor agent systems; and
providing one or more initialization instructions to the learner agent system and the one or more instructor agent systems.

12. The computer-implemented method of claim 11, wherein the one or more initialization instructions comprise one or more of an introductory instruction, a transfer learning instruction, a prior learning instruction, or a tool availability instruction.

13. The computer-implemented method of claim 1, wherein obtaining the at least one training task comprises generating the at least one training task using the one or more instructor agent systems.

14. The computer-implemented method of claim 13, wherein generating the at least one training task using the one or more instructor agent systems comprises:
evaluating a performance capability of the learner agent system on the skillset; and
generating, using the one or more instructor agent systems, the at least one training task based on the performance capability of the learner agent system on the skillset.

15. The computer-implemented method of claim 1, wherein obtaining the at least one training task comprises retrieving the at least one training task from a training task dataset comprising the at least one training task.

16. The computer-implemented method of claim 1, wherein the instructor feedback data comprises contextual feedback relative to a portion of the learner solution.

17. The computer-implemented method of claim 1, wherein the method further comprises, subsequent to training the learner agent system based on the learner solution, generating at least one second training task representative of the skillset.

18. The computer-implemented method of claim 1, wherein the method further comprises, subsequent to training the learner agent system based on the learner solution:
obtaining a request from a user to perform an inference task representative of the skillset; and
generating an output of the learner agent system by performing the inference task;
wherein the learner agent system is enabled to perform the inference task based on training the learner agent system.

19. A computing system, comprising:
one or more processors; and
one or more non-transitory, computer-readable media storing instructions that, when implemented, cause the one or more processors to perform operations, the operations comprising:
identifying a skillset to augment in a learner agent system;
selecting, from a pool of candidate instructor agent systems associated with a multiagent training platform, one or more instructor agent systems based on instructor skills documentation data descriptive of respective skill capabilities of the candidate instructor agent systems;
obtaining at least one training task representative of the skillset;
generating a learner solution to the at least one training task using the learner agent system;
generating instructor feedback data using the one or more instructor agent systems and the at least one training task, the instructor feedback data descriptive of a quality of the learner solution; and
training the learner agent system based on the instructor feedback data.

20. One or more non-transitory, computer-readable media storing instructions that, when implemented, cause one or more processors to perform operations, the operations comprising:
identifying a skillset to augment in a learner agent system;
selecting, from a pool of candidate instructor agent systems associated with a multiagent training platform, one or more instructor agent systems based on instructor skills documentation data descriptive of respective skill capabilities of the candidate instructor agent systems;
obtaining at least one training task representative of the skillset;
generating a learner solution to the at least one training task using the learner agent system;
generating instructor feedback data using the one or more instructor agent systems and the at least one training task, the instructor feedback data descriptive of a quality of the learner solution; and
training the learner agent system based on the instructor feedback data.
